(19) United States
(12) Patent Application Publication
(10) Pub. No.: US 2024/0170866 A1
(43) Pub. Date: May 23, 2024

(54) MULTI-POLE ELECTRICAL WIRING DEVICES WITH WIRE TERMINATION ASSEMBLIES

(71) Applicant: Hubbell Incorporated, Shelton, CT (US)

(72) Inventors: Thomas L. Scanzillo, Monroe, CT (US); Denny Lo, Bethlehem, CT (US); Ryan Gene Papageorge, Shelton, CT (US); Scott Wurms, Shelton, CT (US); Roy J. Itzler, Orange, CT (US)

(21) Appl. No.: 18/511,929

(22) Filed: Nov. 16, 2023

Related U.S. Application Data
(60) Provisional application No. 63/425,891, filed on Nov. 16, 2022.
(60) Provisional application No. 63/449,692, filed on Mar. 3, 2023.
(60) Provisional application No. 63/449,700, filed on Mar. 3, 2023.
(60) Provisional application No. 63/449,708, filed on Mar. 3, 2023.

(51) Int. Cl. H01R 9/24

(52) U.S. Cl. CPC H01R 9/2416

(57) ABSTRACT

Multi-pole or multi-phase electrical wiring devices that incorporate clamp-type wire termination assemblies are described. The electrical wiring devices include multi-pole motor switches. The electrical wiring devices include a plurality of wire termination assemblies. Each wire termination assembly includes a wire terminal and an activating member.

### CROSS-REFERENCE TO RELATED APPLICATIONS

The present application is based on and claims benefit from co-pending U.S. Provisional Patent Application No. 63/425,891 filed on Nov. 16, 2023 entitled “Multi-Pole Electrical Wiring Devices with Wire Termination Assemblies”, and from co-pending U.S. Provisional Application No. 63/449,692 filed on Mar. 3, 2023 entitled “Multi-Pole Electrical Wiring Devices with Wire Termination Assemblies” and from co-pending U.S. Provisional Application No. 63/449,700 filed on Mar. 3, 2023 entitled “Multi-Pole Electrical Wiring Devices with Wire Termination Assemblies” and from co-pending U.S. Provisional Application No. 63/449,708 filed on Mar. 3, 2023 entitled “Multi-Pole Electrical Wiring Devices with Wire Termination Assemblies” the contents of each are incorporated herein in their entirety by reference.

### BACKGROUND

### Field

The present disclosure relates generally to wire termination assemblies for multi-phase or multi-pole electrical wiring devices, and more particularly to screwless wire termination assemblies for use in multi-pole or multi-phase disconnect switches.

### Description of the Related Art

Present electrical wire terminations in many electrical wiring devices are either direct pressure type terminations or screw and clamp type terminations. In direct pressure type terminations, a terminal screw is tightened directly against an electrical wire to press the wire against a fixed plate. In screw and clamp type terminations, a wire is inserted between a fixed plate and a movable plate, and a terminal screw is tightened so that the wire is clamped between the plates. Screw terminations increase the time it takes to install the electrical wiring devices, especially multi-pole electrical wiring devices where two or more wires have to be connected to the wiring device. For example, for three-phase electrical motors, are typically controlled by a motor disconnect switch. Current motor disconnect switches are typically terminated using threaded fasteners, e.g., screws, that are sensitive to torque requirements to achieve proper wire termination strength. Additionally, the screw terminations may loosen when the motor disconnect switch is subjected to vibrations.

### SUMMARY

The present disclosure provides embodiments of various multi-pole or multi-phase electrical wiring devices, including, but not limited to, motor disconnect switches and load control switches. An exemplary embodiment of a multi-pole electrical wiring device includes a housing, at least one wire termination assembly and at least one activating member. The housing has an interior that is at least partially hollow. The housing includes at least one wire receiving opening positioned in a side wall of the housing and at least one activating member opening positioned in a top wall of the housing. The at least one wire termination assembly is positioned in the hollow portion of the interior of the housing such that the at least one wire termination assembly is accessible from the at least one wire receiving opening in the housing. The at least one wire termination assembly may include a biasing member, e.g., a spring. The at least one activating member extends at least partially through the at least one activating member opening. The activating member is interactive with the at least one wire termination assembly such that movement of the activating member in a first direction to a first position causes the at least one wire termination assembly to automatically move to a closed position clamping a wire inserted positioned in the at least one wire termination assembly. When in the closed position, the at least one wire termination assembly can clamp the wire with a force that is substantially perpendicular to a longitudinal axis of the wire. The at least one wire termination assembly may include a wire press member used when clamping the wire positioned in the at least one wire termination assembly. Further, movement of the activating member in a second direction to a second position causes the at least one wire termination assembly to move to an open position releasing the wire within the at least one wire termination assembly. In an exemplary embodiment, the at least one activating member may remain in the first position or the second position until manually moved. In other exemplary embodiments, the movement of the activating member in the second direction may be opposite the movement of the activating member in the first direction. Movement of the activating member in the first direction and the second direction may be linear movement or motion. However, the movement of the activating member in the first direction and the second direction may be rotational movement or motion, torque movement or motion, pivotable movement or motion and/or twist movement or motion. Movement of the activating member in the first direction may be outward relative to the housing, and movement of the activating member in the second direction may be inward relative to the housing.

Another exemplary embodiment of a multi-pole electrical wiring device includes a housing, a plurality of line side wire termination assemblies and a plurality of load side wire termination assemblies. The housing has an interior that may be at least partially hollow, a plurality of wire receiving openings in a side wall of the housing and a plurality of activating member activating member openings in a top wall of the housing. Each of the plurality of wire receiving openings provides access from an exterior of the housing to the hollow portion of the interior of the housing, and each of the plurality of activating member openings provides access from the exterior of the housing to the hollow portion of the interior of the housing. The plurality of line side wire termination assemblies and the plurality of load side wire termination assemblies are positioned in the hollow portion of the interior of the housing so that one of the plurality of line side wire termination assemblies is accessible from one of the plurality of wire receiving openings and one of the plurality of activating member openings. Each of the plurality of line side wire termination assemblies and the load side wire termination assemblies includes a wire terminal and an activating member. The wire terminal includes a clamp brace and a clamping member. The clamping member is movable between a closed position where a wire can be clamped between the clamping member and the clamp brace, and an open position where the wire can be inserted through the one of the plurality of wire receiving openings in the housing and between the clamping member and the clamp brace. The clamping member may include one or more wire press members where the wire can be clamped between the wire press member and the clamp brace instead of between the clamping member and the clamp brace. Preferably, the clamping member can clamp the wire with a force that is substantially perpendicular to a longitudinal axis of the wire. The activating member extends at least partially through the one of the plurality of activating member openings in the housing. The activating member is interactive with the clamping member so that movement of the activating member in a first direction causes the activating member to apply a mechanical load to the clamping member causing the clamping member to move from the closed position to the open position, and movement of the activating member in a second direction removes the mechanical load from the clamping member so that the clamping member moves from the open position to the closed position.

Another exemplary embodiment of a multi-pole electrical wiring device includes a housing, a plurality of line side wire termination assemblies and a plurality of load side wire termination assemblies. The housing has an interior that may be at least partially hollow, a plurality of wire receiving openings in a side wall of the housing and a plurality of activating member openings in a top wall of the housing. Each of the plurality of wire receiving openings provides access from an exterior of the housing to the hollow portion of the interior of the housing, and each of the plurality of activating member openings provides access from the exterior of the housing to the hollow portion of the interior of the housing. The plurality of line side wire termination assemblies and the plurality of load side wire termination assemblies are positioned in the hollow portion of the interior of the housing such that one of the plurality of line side wire termination assemblies and one of the load side wire termination assemblies are accessible from one of the plurality of wire receiving openings and one of the plurality of activating member openings. Each of the plurality of line side wire termination assemblies and the plurality of load side wire termination assemblies includes a wire terminal and an activating member. The wire terminal includes a clamp brace and a clamping member. The clamping member is movable between a closed position where a wire can be clamped between the clamping member and the clamp brace, and an open position where the wire can be inserted through the one of the plurality of wire receiving openings in the housing and between the clamping member and the clamp brace. The clamping member may include one or more wire press members where the wire can be clamped between the wire press member and the clamp brace instead of between the clamping member and the clamp brace. Preferably, the clamping member can clamp the wire with a force that is substantially perpendicular to a longitudinal axis of the wire. The activating member extends at least partially through the one of the plurality of activating member openings in the housing. The activating member is interactive with the clamping member such that movement of the activating member in a first direction causes the activating member to move the clamping member from the closed position to the open position, and movement of the activating member in a second direction permits the clamping member to automatically move from the open position to the closed position.

Another exemplary embodiment of a multi-pole electrical wiring device includes a housing, a plurality of line side wire termination assemblies and a plurality of load side wire termination assemblies. The housing has an interior that may be at least partially hollow, a plurality of wire receiving openings in a side wall of the housing and a plurality of activating member openings in a top wall of the housing. Each of the plurality of wire receiving openings provides access from an exterior of the housing to the hollow portion of the interior of the housing, and each of the plurality of activating member openings provides access from the exterior of the housing to the hollow portion of the interior of the housing. The plurality of line side wire termination assemblies and the plurality of load side wire termination assemblies are positioned in the interior of the housing such that one of the plurality of line side wire termination assemblies and load side wire termination assemblies is accessible from one of the plurality of wire receiving openings and one of the plurality of activating member openings. Each of the plurality of the line side wire termination assemblies and the load side wire termination assemblies includes a wire terminal and an activating member. The wire terminal includes a clamp brace and a clamping member. The clamping member is movable between a closed position where a wire can be clamped between the clamping member and the clamp brace, and an open position where the wire can be inserted between the clamping member and the clamp brace. The clamping member may include one or more wire press members where the wire can be clamped between the wire press member and the clamp brace instead of between the clamping member and the clamp brace. Preferably, the clamping member can clamp the wire with a force that is substantially perpendicular to a longitudinal axis of the wire. The activating member extends at least partially through the one of the plurality of activating member openings in the housing. The is interactive with the clamping member so that movement of the activating member in a first direction from a first position to a second position causes the activating member to move the clamping member from the closed position to the open position, and movement of the activating member in a second direction permits the clamping member to automatically move from the open position to the closed position, wherein the activating member remains in the first position or the second position until manually moved.

For each of the embodiments contemplated by the present disclosure, the clamping member for the line side wire termination assemblies and the load side wire termination assemblies may be a biasing member. A non-limiting example of a biasing member is a spring. Further, for each of the embodiments contemplated by the present disclosure, movement of the activating member for the line side wire termination assemblies and the load side wire termination assemblies in the second direction is opposite the movement of the activating member in the first direction. Movement of the activating member for the line side wire termination assemblies and the load side wire termination assemblies in the first direction and the second direction may be parallel to the clamp brace. Movement of the activating member for the line side wire termination assemblies and the load side wire termination assemblies in the first direction and the second direction may be linear. However, the movement of the activating member in the first direction and the second direction may be rotational movement or motion, torque movement or motion, pivotable movement or motion and/or twist movement or motion. Movement of the activating member for the line side wire termination assemblies and the load side wire termination assemblies in the first and second directions may be relative to the clamping member. And, movement of the activating member for the line side wire termination assemblies and the load side wire termination assemblies in the first direction may be inward or outward relative to the housing and movement of the activating member in the second direction may be outward or inward relative to the housing.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a top perspective view of an exemplary embodiment of a multi-pole electrical wiring device according to the present disclosure and including an exemplary embodiment of wire termination assemblies according to the present disclosure;

FIG. 2 is a bottom perspective view of the multi-pole electrical wiring device of FIG. 1,

FIG. 3 is an exploded bottom perspective view of the multi-pole electrical wiring device of FIG. 2, illustrating the wire termination assemblies within the multi-pole electrical wiring device;

FIG. 4 is a top plan view of the multi-pole electrical wiring device of FIG. 1, illustrating a plurality of wires staged for insertion into the wire termination assemblies within the multi-pole electrical wiring device;

FIG. 5 is another top perspective view of the multi-pole electrical wiring device of FIG. 1, illustrating electrical wires connected to the wire termination assemblies within the multi-pole electrical wiring device, and an electrical wire staged for insertion into a wire termination assembly within the multi-pole electrical wiring device;

FIG. 6 is a bottom perspective view of another exemplary embodiment of a multi-pole electrical wiring device according to the present disclosure, illustrating a main electrical wiring device and an auxiliary electrical wiring device attached to the main electrical wiring device;

FIG. 7 is an exploded bottom perspective view of the electrical wiring device of FIG. 6, illustrating the auxiliary electrical wiring device separated from the main electrical wiring device;

FIG. 8 is an enlarged perspective view of a portion of the electrical wiring device of FIG. 3 taken from detail 8, illustrating a wire termination assembly within the electrical wiring device;

FIG. 9 is a perspective view of the exemplary embodiment of the wire termination assemblies incorporated into the electrical wiring device of FIG. 8;

FIG. 10 is a side elevation view of two wire termination assemblies within the electrical wiring device of FIG. 3, which when in a closed position forms an electrically conductive path between wires connected to the two wire termination assemblies;

FIG. 11 is the side elevation view of one of the wire termination assemblies of FIG. 10, illustrating the wire termination assembly in a closed position;

FIG. 12 is the side elevation view of the wire termination assembly of FIG. 11, illustrating the wire termination assembly in an open position and an electrical wire being inserted into the wire termination assembly;

FIG. 13 is the side elevation view of the wire termination assembly of FIG. 12, illustrating the wire termination assembly returned to the closed position so that the electrical wire is clamped to the wire termination assembly;

FIG. 14 is a schematic representation of an exemplary use configuration for the multi-pole electrical wiring device according to the present disclosure, illustrating a three-phase motor and a three-phase motor disconnect switch assembly used to control the operation of the motor;

FIG. 15 is an exploded perspective view of the motor disconnect switch assembly of FIG. 14, illustrating a multi-pole electrical wiring device within an enclosure;

FIG. 16 is a schematic representation of another exemplary use configuration for the multi-pole electrical wiring device according to the present disclosure, illustrating of a three-phase motor, a three-phase motor drive unit and a multi-pole motor disconnect switch assembly between the motor and the motor drive unit;

FIG. 17 is an exploded perspective view of the motor disconnect switch assembly of FIG. 16, illustrating a multi-pole main electrical wiring device and an auxiliary electrical wiring device attached to the main electrical wiring device within an enclosure;

FIG. 18 is a top perspective view of another exemplary embodiment of a multi-pole electrical wiring device according to the present disclosure and including another exemplary embodiment of wire termination assemblies according to the present disclosure;

FIG. 19 is an exploded bottom perspective view of the multi-pole electrical wiring device of FIG. 18, illustrating the wire termination assemblies within the multi-pole electrical wiring device;

FIG. 20 is another top perspective view of the multi-pole electrical wiring device of FIG. 18, illustrating electrical wires connected to the wire termination assemblies within the multi-pole electrical wiring device, and an electrical wire staged for insertion into a wire termination assembly within the multi-pole electrical wiring device;

FIG. 21 is a top perspective view of a portion of the multi-pole electrical wiring device of FIG. 20, illustrating a portion of a housing of the multi-pole electrical wiring device cut away to reveal an activating member of one wire termination assembly being inserted into the housing;

FIG. 22 is the top perspective view of the portion of the multi-pole electrical wiring device of FIG. 21, illustrating the activating member inserted into the housing;

FIG. 23 is a cross-sectional view of the portion of the multi-pole electrical wiring device of FIG. 22 taken along line 23-23 and illustrating positions of pins of the activating member in an locking channel;

FIG. 24 is the top perspective view of the portion of the multi-pole electrical wiring device of FIG. 22, illustrating the pins of the activating member moved to the locking channel and in a locking position locking the activating member in the housing;

FIG. 25 is a cross-sectional view of the portion of the multi-pole electrical wiring device of FIG. 24 taken along line 25-25 and illustrating the pins of the activating member in a holding channel applying a mechanical load to a clamping member of the wire termination assembly;

FIG. 26 is the top perspective view of the portion of the multi-pole electrical wiring device of FIG. 24, illustrating removal of the pins of the activating member from the holding channel removing the mechanical load on the clamping member of the wire termination assembly,

FIG. 27 is a side elevation view of two wire termination assemblies within the electrical wiring device of FIG. 19, which when in a closed position form an electrically conductive path between wires connected to the two wire termination assemblies;

FIG. 28 is the side elevation view of one of the wire termination assemblies of FIG. 27, illustrating the wire termination assembly in a closed position;

FIG. 29 is the side elevation view of the wire termination assembly of FIG. 28, illustrating the wire termination assembly being moved toward an open position;

FIG. 30 is the side elevation view of the wire termination assembly of FIG. 29, illustrating the wire termination assembly in an open position and an electrical wire being inserted into the wire termination assembly;

FIG. 31 is the side elevation view of the wire termination assembly of FIG. 30, illustrating the wire termination assembly returned to the closed position and the electrical wire clamped to the wire termination assembly;

FIG. 32 is a top perspective view of another exemplary embodiment of a multi-pole electrical wiring device according to the present disclosure and including another exemplary embodiment of wire termination assemblies according to the present disclosure;

FIG. 33 is an exploded bottom perspective view of the multi-pole electrical wiring device of FIG. 32, illustrating the wire termination assemblies within the multi-pole electrical wiring device;

FIG. 34 is another top perspective view of the multi-pole electrical wiring device of FIG. 32, illustrating electrical wires connected to the wire termination assemblies within the multi-pole electrical wiring device, and an electrical wire staged for insertion into a wire termination assembly within the multi-pole electrical wiring device;

FIG. 35 is a side elevation view of two wire termination assemblies within the electrical wiring device of FIG. 32, which when in a closed position form an electrically conductive path between wires connected to the two wire termination assemblies;

FIG. 36 is the side elevation view of one of the wire termination assemblies of FIG. 35, illustrating the wire termination assembly in a closed position;

FIG. 37 is the side elevation view of the wire termination assembly of FIG. 36, illustrating the wire termination assembly in an open position and an electrical wire being inserted into the wire termination assembly;

FIG. 38 is the side elevation view of the wire termination assembly of FIG. 37, illustrating the wire termination assembly returned to the closed position and the electrical wire clamped to the wire termination assembly;

FIG. 39 is a top perspective view of another exemplary embodiment of a multi-pole electrical wiring device according to the present disclosure and including another exemplary embodiment of wire termination assemblies according to the present disclosure;

FIG. 40 is an exploded bottom perspective view of the multi-pole electrical wiring device of FIG. 39, illustrating the wire termination assemblies within the multi-pole electrical wiring device;

FIG. 41 is another top perspective view of the multi-pole electrical wiring device of FIG. 39, illustrating electrical wires connected to the wire termination assemblies within the multi-pole electrical wiring device, and an electrical wire staged for insertion into a wire termination assembly within the multi-pole electrical wiring device;

FIG. 42 is a side elevation view of two wire termination assemblies within the electrical wiring device of FIG. 39, which when in a closed position form an electrically conductive path between wires connected to the two wire termination assemblies;

FIG. 43 is the side elevation view of one of the wire termination assemblies of FIG. 42, illustrating the wire termination assembly in a closed position;

FIG. 44 is the side elevation view of the wire termination assembly of FIG. 43, illustrating the wire termination assembly in an open position and an electrical wire being inserted into the wire termination assembly;

FIG. 45 is the side elevation view of the wire termination assembly of FIG. 44, illustrating the wire termination assembly returned to the closed position and the electrical wire clamped to the wire termination assembly;

FIG. 46 is a top perspective view of another exemplary embodiment of a multi-pole electrical wiring device according to the present disclosure and including another exemplary embodiment of wire termination assemblies according to the present disclosure;

FIG. 47 is the side elevation view of one of the wire termination assemblies of FIG. 46, illustrating the wire termination assembly in a closed position;

FIG. 48 is the side elevation view of the wire termination assembly of FIG. 47, illustrating the wire termination assembly in an open position and an electrical wire being inserted into the wire termination assembly;

FIG. 49 is the side elevation view of the wire termination assembly of FIG. 48, illustrating the wire termination assembly returned to the closed position and the electrical wire clamped to the wire termination assembly;

FIG. 50 is atop perspective view of another exemplary embodiment of a multi-pole electrical wiring device according to the present disclosure and including another exemplary embodiment of wire termination assemblies according to the present disclosure;

FIG. 51 is the side elevation view of one of the wire termination assemblies of FIG. 50, illustrating the wire termination assembly in a closed position;

FIG. 52 is the side elevation view of the wire termination assembly of FIG. 51, illustrating the wire termination assembly in an open position and an electrical wire being inserted into the wire termination assembly;

FIG. 53 is the side elevation view of the wire termination assembly of FIG. 52, illustrating the wire termination assembly returned to the closed position and the electrical wire clamped to the wire termination assembly;

FIG. 54 is a top perspective view of another exemplary embodiment of a multi-pole electrical wiring device according to the present disclosure and including another exemplary embodiment of wire termination assemblies according to the present disclosure;

FIG. 55 is the side elevation view of one of the wire termination assemblies of FIG. 54, illustrating the wire termination assembly in a closed position;

FIG. 56 is the side elevation view of the wire termination assembly of FIG. 55, illustrating the wire termination assembly in an open position and an electrical wire being inserted into the wire termination assembly;

FIG. 57 is the side elevation view of the wire termination assembly of FIG. 56, illustrating the wire termination assembly returned to the closed position and the electrical wire clamped to the wire termination assembly;

FIG. 58 is atop perspective view of another exemplary embodiment of a multi-pole electrical wiring device according to the present disclosure and including another exemplary embodiment of wire termination assemblies according to the present disclosure;

FIG. 59 is the side elevation view of one of the wire termination assemblies of FIG. 58, illustrating the wire termination assembly in a closed position;

FIG. 60 is the side elevation view of the wire termination assembly of FIG. 59, illustrating the wire termination assembly in an open position and an electrical wire being inserted into the wire termination assembly; and

FIG. 61 is the side elevation view of the wire termination assembly of FIG. 60, illustrating the wire termination assembly returned to the closed position and the electrical wire clamped to the wire termination assembly;

### DETAILED DESCRIPTION

Exemplary embodiments of multi-pole or multi-phase electrical wiring devices that incorporate the wire termination assemblies according to the present disclosure are shown and described. Non-limiting examples of the multi-pole or multi-phase electrical wiring devices contemplated by the present disclosure include motor disconnect switches and load control switches. In some embodiments, the motor disconnect switches may include one or more auxiliary disconnect switches.

For ease of description, the multi-pole or multi-phase electrical wiring devices contemplated by the present disclosure may also be referred to herein as the “electrical wiring devices” in the plural and the “electrical wiring device” in the singular. For ease of description, the wire termination assemblies may also be referred to herein as the “wire terminations” or the “terminations” in the plural and the “wire terminations” or the “termination” in the singular. In addition, the electrical conductors may also be referred to as the “wires” in the plural and the “wire” in the singular. Further, the electrical conductors can be any size wire used to conduct electricity, such as 14 AWG wire, 12 AWG wire, 10 AWG wire or 8 AWG wire. Generally, 14 AWG wires are rated for between 15 and 18 amps, 12 AWG wires are rated for between 20 and 25 amps, 10 AWG wires are rated for between 25 and 30 amps, 8 AWG wires are rated for between 35 and 40 amps, and 6 AWG wires are rated for between 45 and 50 amps.

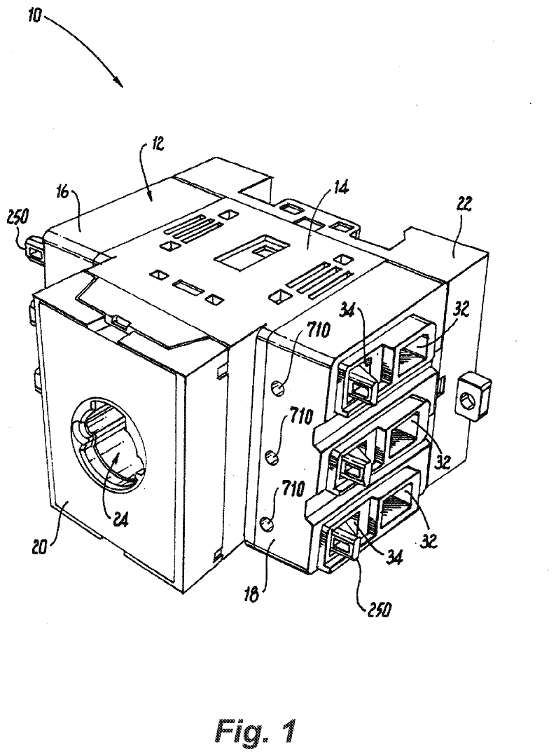

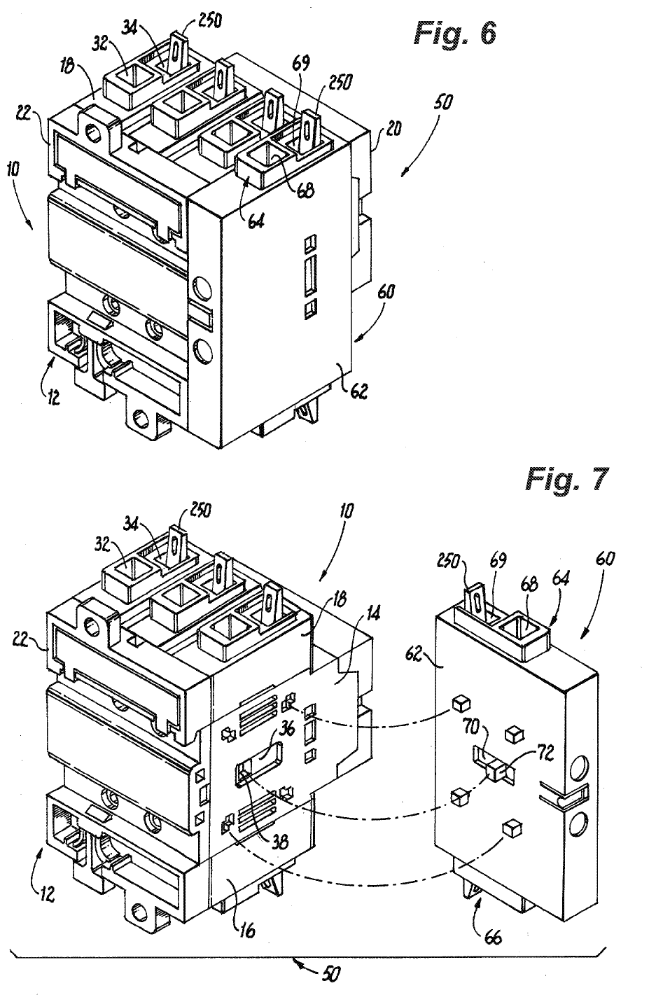

In the exemplary embodiment shown in FIGS. 1-5, the electrical wiring device may be a multi-pole switch, e.g., a three-pole switch. In the exemplary embodiment shown in FIGS. 6 and 7, the multi-pole or multi-phase electrical wiring device combines the multi-pole switch of FIGS. 1-5 with an auxiliary switch. For ease of description, the multi-pole switch may also be referred to herein as the “switch” in the singular and the “switches” in the plural. The switches and auxiliary switches contemplated may be used to control the operation of multi-phase motors, e.g., three-phase motors.

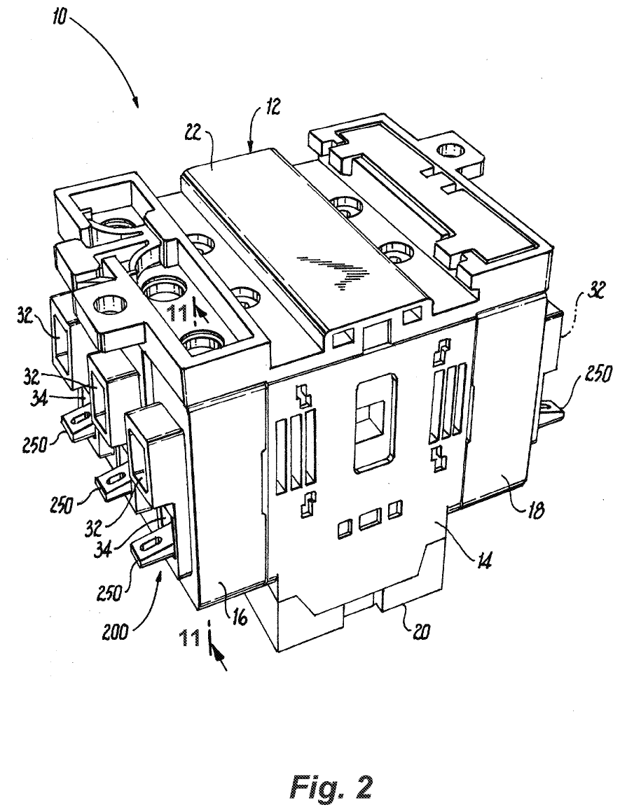

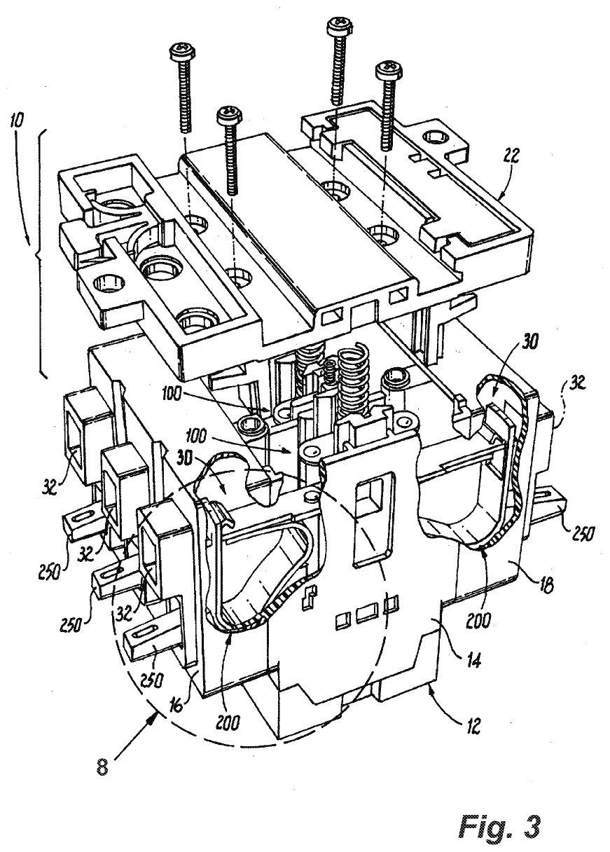

Referring to the exemplary embodiment of FIGS. 1-5, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. Within the main body portion 14 of the housing 12 are the components that perform the make and break functions of the switch 10. A non-limiting example of the components within the main body portion that perform the make and break functions of the switch 10 are included in, for example, the HBLDS3RS Disconnect Switch sold by Hubbell Incorporated, which is incorporated herein in its entirety by reference. Generally, the main portion 14 includes a plurality of spring loaded switch contacts 100, seen in FIG. 3, that are accessible when the base 22 is removed from the housing 12. Each switch contact 100 acts as a jumper between corresponding pairs of wire termination assemblies 200 positioned at least partially within and accessible from the wire attachment portions 16 and 18. The top portion 20 of the housing 12 includes an on-off control assembly 24. The on-off control assembly 24 is operatively coupled to the switch contacts 100 such that the on-off control assembly 24 moves the switch contacts 100 between make and break positions. Each wire attachment portion 16 and 18 is secured to or integrally formed into the main body portion 14. In the exemplary embodiment shown, each wire attachment portion 16 and 18 includes one or more wire termination chambers or cavities 30, seen in FIG. 3, one or more wire receiving openings 32 and one or more activating member activating member openings 34, seen in FIGS. 1 and 2. Each wire termination chamber or cavity 30 is configured to receive and position a wire terminal assembly 200 within the wire attachment portion 16 or 18, as shown in FIG. 3. In this configuration, one of the one or more wire receiving openings 32 and one of the one or more activating member openings 34 provide access from an exterior of the housing to one of the one or more wire termination chambers or cavities 30.

Referring to the exemplary embodiment of FIGS. 6 and 7, the multi-pole or multi-phase electrical wiring device is a switch 50 that combines the multi-pole switch 10 of FIGS. 1-5 and one or more auxiliary switches 60. In the embodiment shown, there is a single auxiliary switch shown. The auxiliary switch 60 has a housing 62 that includes a pair of wire attachment portions 64 and 66. The housing 62 is preferably made of suitably rigid electrical insulating materials, such as plastic materials, including injection molded thermoplastic materials, such as Nylon, and can be a standalone unit or configured to fit within an electrical enclosure. Within the housing 62 are the components that perform the make and break functions of the switch 60. A non-limiting example of the components within the housing 62 that perform the make and break functions of the switch 60 are included in, for example, the HBLAC2 Auxiliary Disconnect Switch sold by Hubbell Incorporated, which is incorporated herein in its entirety by reference. Generally, housing 62 includes a spring loaded switch contact (not shown) that is similar to the switch contacts 100, seen in FIG. 3 and described above. The switch contact 100 acts as jumper between corresponding pairs of wire termination assemblies 200 positioned at least partially within the wire attachment portions 64 and 66, similar to that shown in FIG. 3. To move the switch contact between the make and break positions, a switch arm lever 70 is operatively coupled to the components within the housing 62 that perform the make and break functions of the switch 60. More specifically, the main body 14 of the housing 12 of the switch 10 has auxiliary trigger arm 36 operatively coupled to the components in the main body 14 of the housing 12 that are the components that perform the make and break functions of the switch 10. The auxiliary trigger arm 36 has a recess 38 that is accessible from an exterior of the main body 14 of the housing 12, as seen in FIG. 7. In addition, the switch arm lever 70 includes a tab 72 extending from the housing 62, as seen in FIG. 7. The tab 72 is configured and dimensioned to be received in the recess 38 of the auxiliary trigger arm 36 so that when the switch 10 is in the make position the auxiliary trigger arm 36 causes the switch arm lever 70 to move the switch contact within the housing 62 to a make position, and when the switch 10 is in the break position the auxiliary trigger arm 36 causes the switch arm lever 70 to move the switch contact within the housing 62 to a break position.

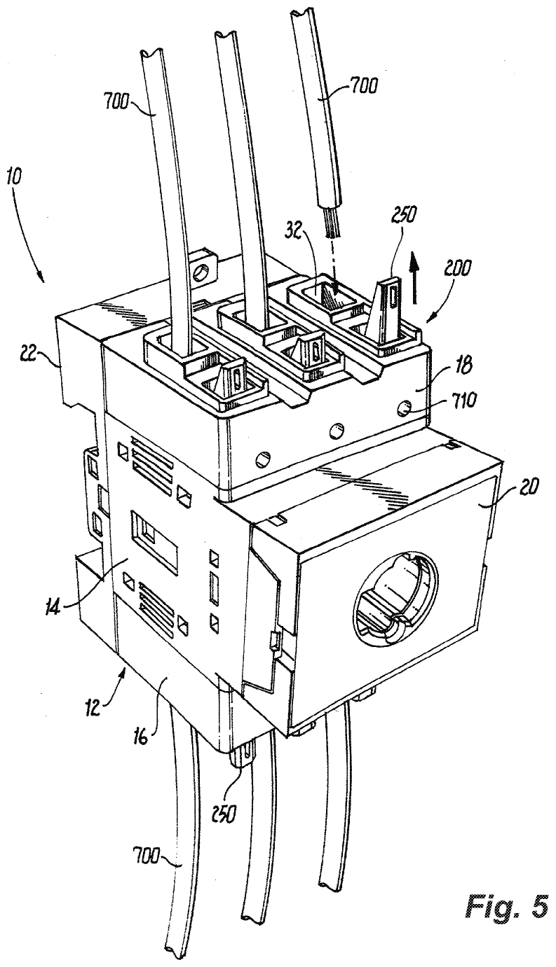

Continuing to refer to FIGS. 6 and 7, the housing 62 includes one or more chambers or cavities (not shown) that are similar to the chambers or cavities 30 described above. Each chamber or cavity is configured to receive and position a wire termination assembly 200 within the housing 62. Each wire attachment portion 64 and 66 is secured to or integrally formed into the housing 62, and includes a wire opening 68 and an activating member opening 69. In this configuration, one of the plurality of wire receiving openings 68 and one of the plurality of activating member openings 69 provide access from an exterior of the housing 62 to one of the plurality of chambers or cavities within the housing 62. Each wire terminal assembly 200 is configured to receive and clamp a wire, such as wire 700 shown in FIG. 5, to the switch 60, and to mate with the switch contact of the switch 60.

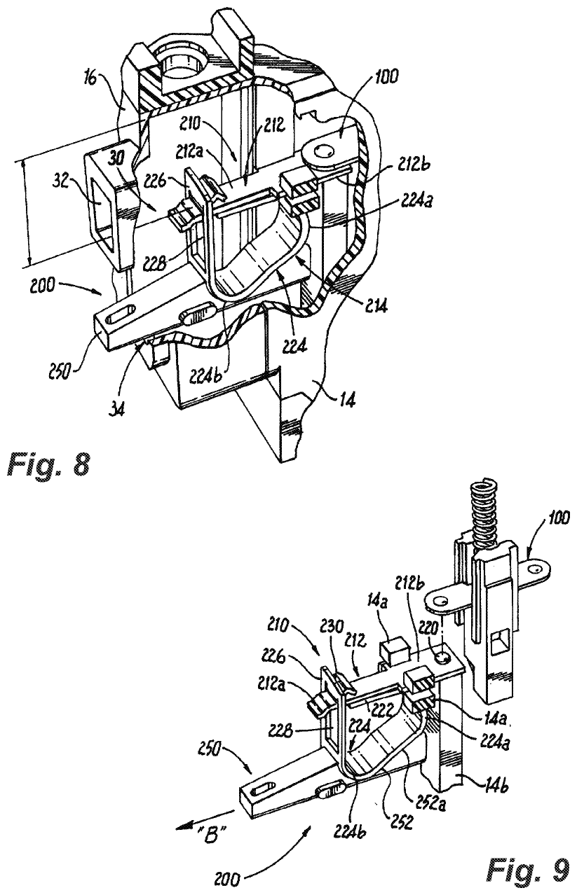

Turning to FIGS. 8-10, an exemplary embodiment of a wire termination assembly 200 according to the present disclosure is shown. Each wire termination assembly 200 is configured to receive and clamp a wire, such as wire 700 shown in FIG. 5, to the switch 10, and to mate with the switch contacts 100 of the switch 10. In the exemplary embodiment shown, the wire termination assembly 200 includes a wire terminal 210 and an activating member 250. The wire terminal 210 is at least partially made of an electrically conductive material, such as brass, copper or aluminum. In an exemplary embodiment, at least a portion of the wire terminal 210 is made of a resilient material with sufficient stiffness to flex when a mechanical load is applied and return to its normal position when the mechanical load is removed. An example of such a resilient material is spring steel. The wire terminal 210 can be formed as a unitary or monolithic structure, or the wire terminal 210 can be individual components mechanically fitted together, e.g., clipped together, or secured together by, for example, a solder joints, a brazed joints, or a welded joints. The activating member 250 is made of suitably rigid electrical insulating materials, such as plastic materials. Non-limiting examples of plastic materials include injection molded thermoplastic materials, such as Nylon. The activating member 250 may also be referred to herein as a “plunger” in the singular and “plungers” in the plural.

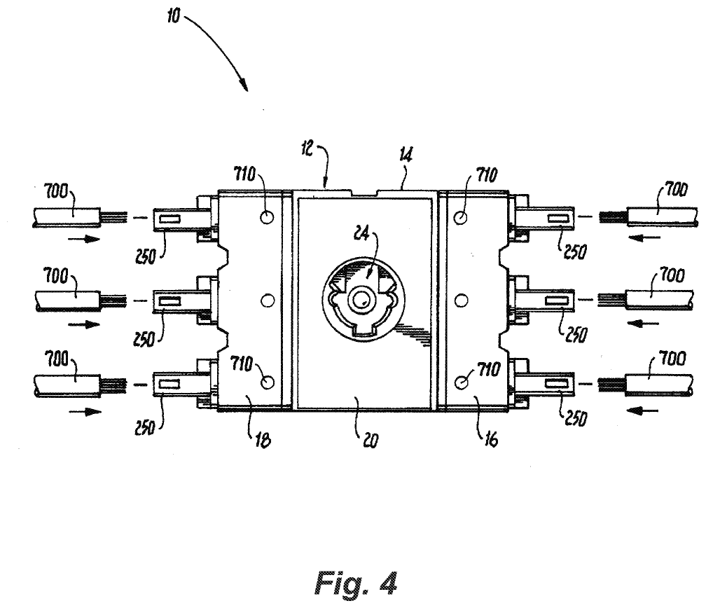

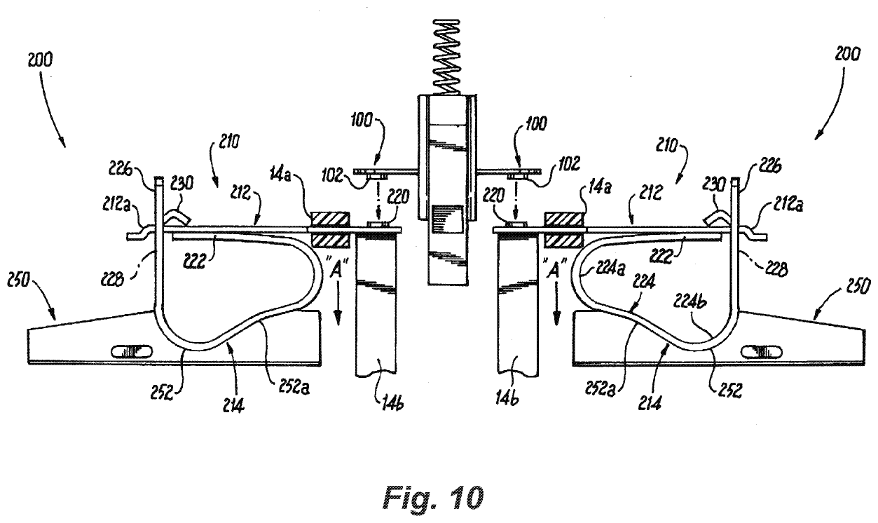

Continuing to refer to FIGS. 8-10, the wire terminal 210 is a mechanical clamping terminal that may use one or more clamping members 214 that can deflect under a mechanical load applied by the plunger 250 and recover to their initial shape when the mechanical load is removed. The energy stored by the one or more clamping members 214 should be sufficient to apply a constant and continuous force to mechanically secure one or more wires, e.g., wires 700 shown in FIGS. 4 and 5, to the wire terminal 210. In the exemplary configuration shown in FIGS. 8-10, the wire terminal 210 includes a clamp brace 212 and a clamping member 214. The clamp brace 212 is an electrically conductive fixed terminal body that may be a substantially planar shaped member or an arcuate shaped member having a first end 212a secured to the clamping member 214. The clamp brace 212 may be secured to the clamping member 214 by, for example, mechanically fitting, e.g., clipping, the clamp brace 212 to the clamping member 214 or a solder joint, a brazed joint, or a welded joint. The clamp brace 212 has a second end 212b that extends from the wire attachment portion 16 or 18 into the main body portion 14 of the housing 12. Preferably, the second end 212b of the clamp brace 212 is fixed or secured to the main body portion 14 of the housing 12 to limit and possibly prevent flexing of the second end 212b of the clamp brace 212 during operation of the switch 10. In an exemplary embodiment, a portion of the second end 212b of the clamp brace 212 may be positioned within slots on a portion 14a of the main body portion 14. Further, a portion of the second end 212b of the clamp brace 212 may rest on or be secured to a wall 14b within the main body portion 14 of the housing, as shown in FIGS. 9 and 10. By resting the second end 212b of the clamp brace 212 on or securing the second end 212b of the clamp brace 212 to the wall 14b, flexing of the second end 212b of the clamp brace 212 in the direction of arrow “A” is limited or possibly prevented. The second end 212b of the clamp brace 212 may include an electrical contact pad 220 that is configured and dimensioned to contact an electrical contact pad 102 on the switch contact 100, as shown in FIG. 10.

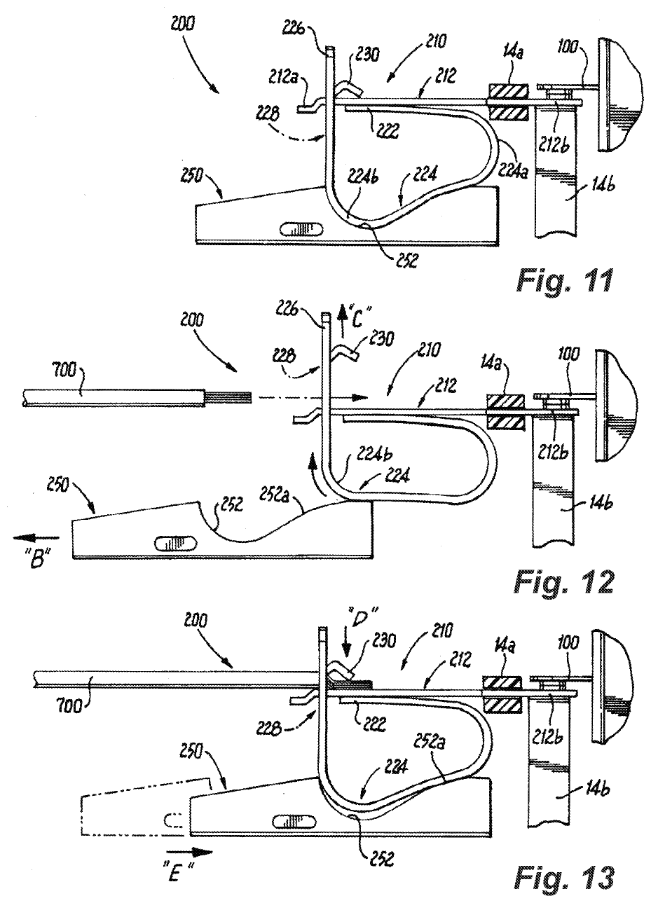

Referring to FIGS. 8-13, in the exemplary embodiment shown, the clamping member 214 includes a brace contact member 222, a biasing member 224 and a clamp arm 226. The brace contact member 222 can be a substantially planar shaped member or an arcuate shaped member that is configured to mate with the clamp brace 212 and is mechanically fitted to, e.g., clipped to, the clamp brace 212 or secured to the clamp brace by, for example, a solder joint, a brazed joint, or a welded joint. A non-limiting example of the biasing member 224 is a spring, such as a clamp spring. In the embodiments shown, the biasing member 224 is a spring. However, the present disclosure contemplates other types of mechanisms that can apply a constant and continuous force on the wire to electrically clamp, couple or otherwise connect the wire 700 to the wire terminal 210 in various temperatures and environmental conditions. The biasing member 224 has a first lobe 224a and a second lobe 224b. The first lobe 224a and the second lobe 224b are configured to interact with the plunger 250 so that movement of the plunger relative to the biasing member 224 is translated to the application of a mechanical load on the biasing member 224 or the removal of the mechanical load on the biasing member 224. For example, the plunger 250 can be a rectangular shaped member having a notch 252 that is configured to receive the second lobe 224b of the biasing member 224, as shown in FIGS. 8 and 10. The notch 252 has a camming surface 252a that rides along the biasing member 224 when the plunger 250 is moved in the direction of arrow “B,” seen in FIG. 12, applying a mechanical load on the biasing member 224 causing the biasing member to deflect in the direction of arrow “C” toward the open position. The clamp arm 226 extends from the second lobe 224b of the biasing member 224 toward the clamp brace 212, as shown. The clamp arm 226 has an elongated opening 228 configured to receive a portion of the clamp brace 212 and at least a portion of a wire press member 230. The wire press member 230 is configured to contact and press a wire, e.g., wire 700 seen in FIGS. 12 and 13, against the clamp brace 212 when the wire is positioned between the clamp brace 212 and the wire press member 230 and the clamping member 214 is in the closed position, as shown in FIG. 13. The clamp arm 226 is movable relative to the clamp brace 212 between the closed position, seen in FIGS. 11 and 13, and the open position, seen in FIG. 12.

As noted, the wire terminal 210 can connect to electrical conductors of different sizes. For example, if the electrical wiring device, e.g., switch 10, is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring device is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring device is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit. As another example, if the blade-type electrical receptacle is rated for 50 amps, then the wire terminal 210 should also be rated for at least 50 amps. The wire size, i.e., the bare conductor size, for 50 amps is 6 AWG wire such that the clamp arm 226 should be able to move to an open position where the outer diameter of 6 AWG wire can fit.

The biasing member 224 is made of a resilient material with sufficient stiffness to flex when the plunger 250 pushes the biasing member 224 from the closed position, seen in FIG. 11, to the open position, seen in FIG. 12. As noted, when in the closed position, the biasing member 224 can apply a force, e.g., a spring force, through the wire press member 230 to a wire 700 inserted between the wire press member 230 and the clamp brace 212, as shown in FIG. 13. A non-limiting example of the biasing member 224 is a spring, such as a clamp spring. In the embodiments shown, the biasing member 224 is a spring. However, the present disclosure contemplates other types of mechanisms that can apply a constant and continuous force on the wire to electrically clamp, couple or otherwise connect the wire 700 to the wire terminal 210 in various temperatures and environmental conditions. The biasing member 224 can be made of metal, such as spring steel. The biasing force, e.g., spring force, exerted by the biasing member 224 clamping a wire between the wire press member 230 and the clamp brace 212 should be sufficient to apply a constant and continuous force on the wire to electrically clamp, couple or otherwise connect the wire 700 to the wire terminal 210 in various temperatures and environmental conditions. The biasing member 224 is configured so that it is normally biased toward the closed position, i.e., in the direction of arrow “D” which is away from the clamp brace 212, as seen in FIG. 13. In the normal position of the biasing member 224 without a conductor inserted into the elongated opening 228, the wire press member 230 of the clamp arm 226 can contact the clamp brace 212, as shown in FIG. 11.

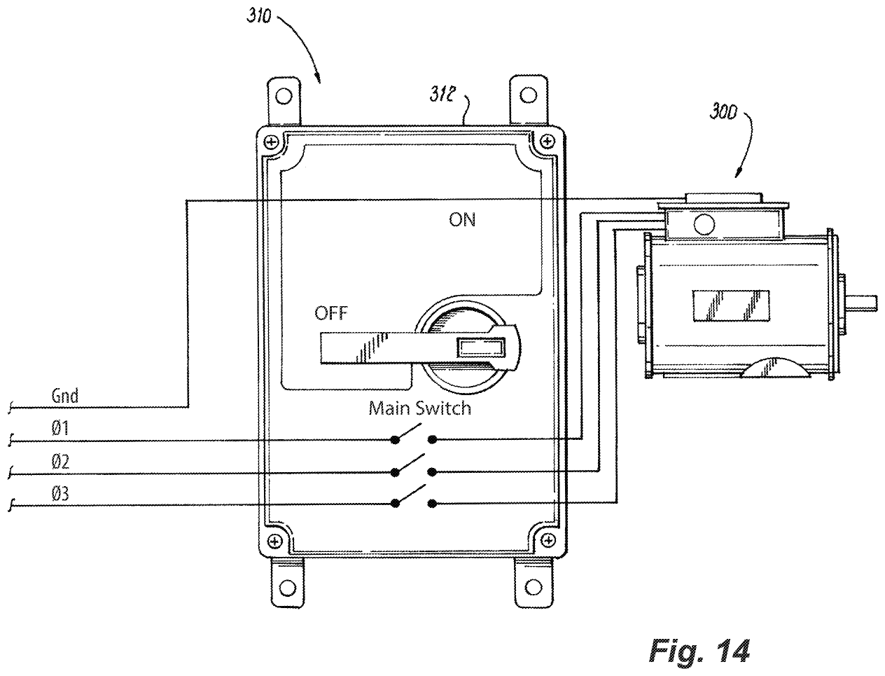

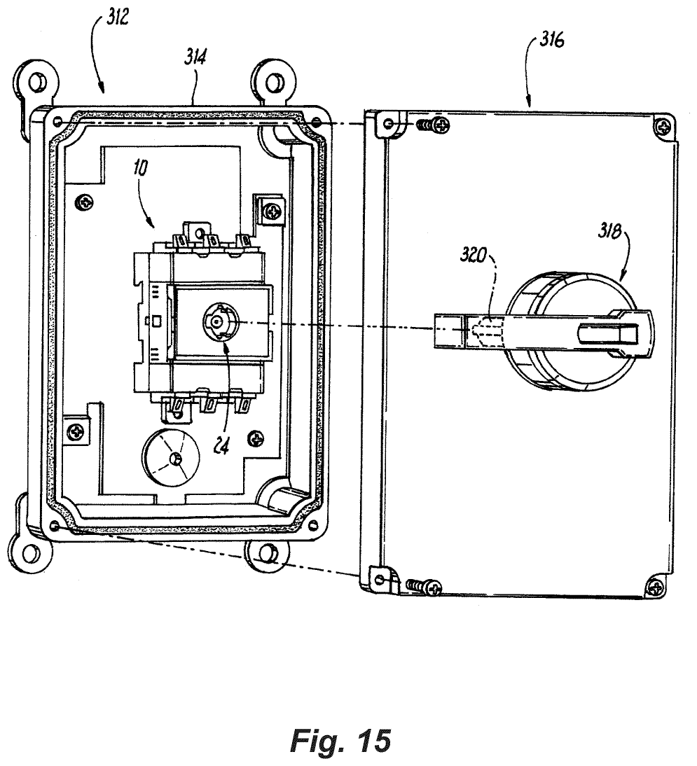

Referring to FIGS. 11-15, an exemplary embodiment of a use scenario for the switch 10 described herein is shown. In this exemplary embodiment, a 30 amp, three-phase electrical motor 300 is controlled by a disconnect switch assembly 310. The disconnect switch assembly 310 includes an electrical enclosure or electrical box 312 having a main body 314 and a removable cover 316. For ease of description, the electrical enclosure or electrical box 312 may also be referred to herein as the “enclosure” in the singular and the “enclosures” in the plural. The enclosure 312 may be a weatherproof or watertight enclosure. A switch 10 is secured in the main body 314 of the enclosure 312. As described herein, the switch 10, seen in FIG. 1, uses wire termination assemblies 200 to terminate electrical conductors or wires within the enclosure 312. To connect wires within the enclosure 312 to the switch 10, an installer, e.g., an electrician, strips the insulation from the end of each wire, as shown in FIG. 12. In the exemplary embodiment shown in FIGS. 14-15, the switch 10 is a three-pole switch that has six wire termination assemblies 200, such that six wires can be connected to the switch 10. The six wires include line side phase 1, phase 2 and phase 3 wires, and load side phase 1, phase 2 and phase 3 wires. However, it is also contemplated that each wire termination assemblies 200 could be configured to electrically connect more than one wire to the wire termination assemblies 200. The plunger 250 for each wire termination assembly 200 extends through the activating member opening 34 in the wire attachment portions 16 or 18 of the switch housing 12. The portion of the plunger 250 extending from the housing 12 are then moved, e.g., pulled, in the direction of arrow “B,” seen in FIG. 12, which in this case is outward relative to the wire attachment portions 16 or 18 of the housing 12. Moving the plunger 250 in the direction of arrow “B” causes the camming surface 252a of the notch 252 in the plunger 250 to ride along the biasing member 224 applying a mechanical load on the biasing member 224. Applying a mechanical load on the biasing member 224, causes the biasing member 224 to deflect in the direction of arrow “C,” seen in FIG. 12, from the closed position toward the open position. With the wire terminals 210 in the open position, the electrical wires 700 are then inserted into the appropriate wire receiving openings 32 in the wire attachment portions 16 or 18 of the switch housing 12, seen in FIG. 5. The wire receiving openings 32 also guide the bare end of the wires 700 into the portion of the elongated opening 128 of the clamping member 214 between clamp brace 212 and wire press member 230. When the bare end of each wire 700 is positioned between the clamp brace 212 and the wire press member 230, the respective plunger 250 is then moved, e.g., pushed in the direction of arrow “E,” seen in FIG. 13, back into the activating member opening 34 in the wire attachment portions 16 or 18. Moving the plungers 250 in the direction of arrow “E” removes the mechanical load applied by the plunger 250 on the biasing member 224 so that the energy stored by the biasing member 224 moves the biasing member 224 to the closed position with sufficient force to secure or clamp the wire 700 between the clamp brace 212 and the wire press member 230 completing an electrically conductive path between the wire 700 and the wire termination assembly 200. It is noted that when the plunger 250 is moved in the direction of arrow “B” to a first position, plunger 250 extends out of the wire attachment portion 16 or 18 of the housing 12 a distance that is greater than when the plunger 250 is moved in the direction of arrow “E” to a second position, as shown in FIG. 5. The second direction may be a direction that is opposite the first direction. In addition, it is noted that when the plunger is moved to the first position or the second position, the plunger 250 may remain in the first position or the second position until the plunger is manually moved to the other position.

With the wires 700 connected to the switch 10 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 10 into engagement with the electrical contact pads 220 on the clamp brace 212 of the wire termination assemblies 200 completing an electrically conductive path from the wires 700 to the motor 300 turning the motor on.

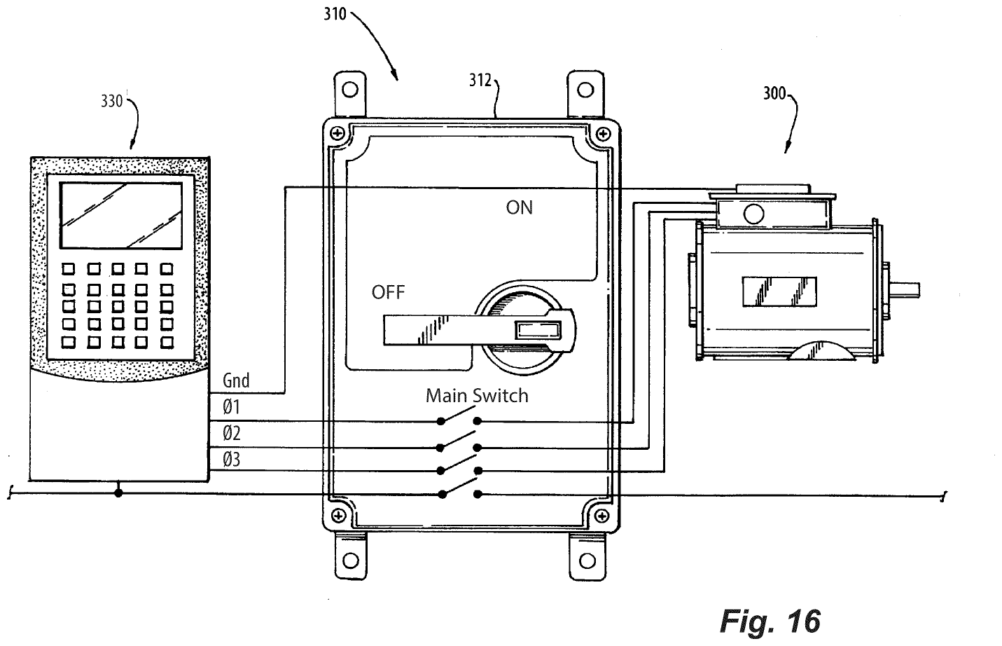

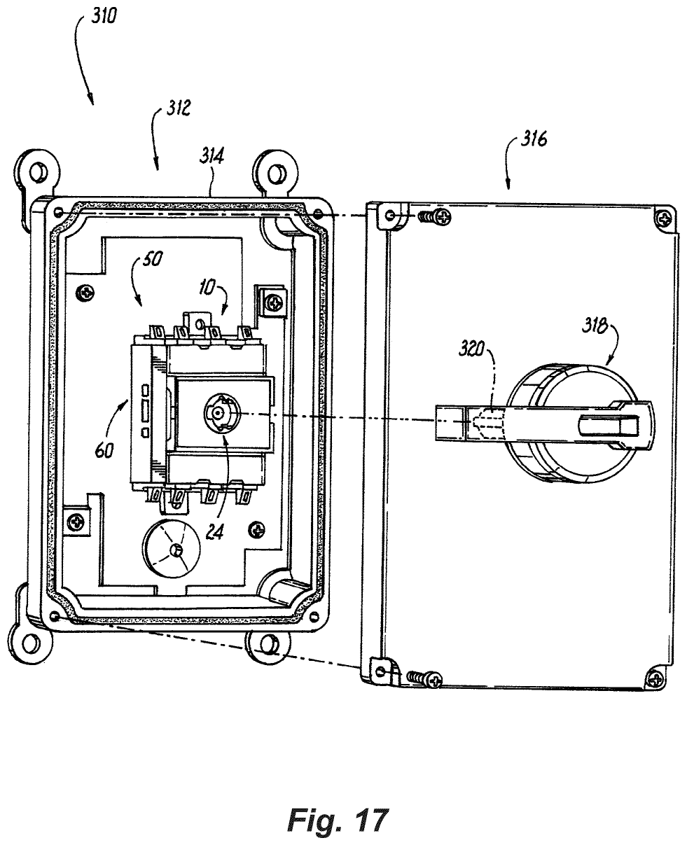

Referring to FIGS. 11-13, 16 and 17, an exemplary embodiment of a use scenario for the switch 50 described herein is shown. In this exemplary embodiment, a 30 amp, three-phase electrical motor 300 is controlled by a disconnect switch assembly 310 and a motor driver 330. The disconnect switch assembly 310 is the same as described above, except the switch 50 is used instead of switch 10. To connect wires within the enclosure 312 to the switch 50, an installer, e.g., an electrician, strips the insulation from the end of each wire. In the exemplary embodiment shown in FIGS. 16-17, the switch 10 is a three-pole switch that has six wire termination assemblies 200, such that six wires can be connected to the switch 10. The six wires include line side phase 1, phase 2 and phase 3 wires, and load side phase 1, phase 2 and phase 3 wires. In addition, the auxiliary switch 60 is a single pole switch with a line and load side control wires.

The plunger 250 for each wire termination assembly 200 of switch 10 extends through the activating member opening 34 in the wire attachment portions 16 or 18 of the switch housing 12, and the plunger 250 for each wire termination assembly 200 of switch 10 extends through the activating member opening 69 in the wire attachment portions 64 or 66 of the auxiliary switch housing 62. The portion of the plunger 250 extending from the housings 12 and 62 are then moved, e.g., pulled, in the direction of arrow “B,” seen in FIG. 12. Moving each plunger 250 in the direction of arrow “B” causes the camming surface 252a of the notch 252 in the plunger 250 to ride along the biasing member 224 applying a mechanical load on the spring member 224. Applying a mechanical load on the biasing member 224, causes the biasing member 224 to deflect in the direction of arrow “C,” seen in FIG. 12, from the closed position toward the open position. With the wire terminals 210 in the open position, the electrical wires 700 are then inserted into the appropriate wire receiving openings 32 in the wire attachment portions 16 or 18 of the switch housing 12 and the wire receiving openings 68 in the wire attachment portions 64 or 66 of the auxiliary switch housing 62. The wire receiving openings 32 and 68 also guide the bare end of the wires 700 into the portion of the elongated opening 128 of the clamping member 214 between clamp brace 212 and wire press member 230. When the bare end of each wire 700 is positioned between the clamp brace 212 and the wire press member 230, the respective plunger 250 is then moved, e.g., pushed in the direction of arrow “E.”. Moving the plungers 250 in the direction of arrow “E” removes the mechanical load applied by the plunger 250 on the biasing member 224 so that the energy stored by the biasing member 224 moves the biasing member 224 to the closed position with sufficient force to secure or clamp the wire 700 between the clamp brace 212 and the wire press member 230 completing an electrically conductive path between the wire 700 and the wire termination assembly 200. It is noted that when the plunger 250 is moved in the direction of arrow “B” to a first position, plunger 250 extends out of the wire attachment portion 16 or 18 of the housing 12 a distance that is greater than when the plunger 250 is moved in the direction of arrow “E” to a second position, as shown in FIG. 5. The second direction may be a direction that is opposite the first direction. In addition, it is noted that when the plunger is moved to the first position or the second position, the plunger 250 may remain in the first position or the second position until the plunger is manually moved to the other position.

With the wires 700 connected to the switch 50, the motor driver 330 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 50 into engagement with the electrical contact pads 220 on the clamp brace 212 of the wire termination assemblies 200 completing an electrically conductive path from the wires 700 to the motor 300 and providing power to the motor driver 330. The motor driver 330 can then be programmed to turn the motor 300 “on” and “off”.

For the embodiments of FIGS. 14-17, to remove wires from the wire termination assemblies 200, the plungers 250 for each wire termination assembly 200 extending through the activating member opening 34 in the wire attachment portions 16 or 18 of the switch housing 12 and/or activating member opening 69 of the switch housing 62 are moved in the direction of arrow “B,” seen in FIG. 12. Moving the plungers 250 in the direction of arrow “B” causes the camming surface 252a of the notch 252 in the plunger 250 to ride along the biasing member 224 applying a mechanical load on the biasing member 224 causing the biasing member to deflect from the closed position to the open position as described above. With the wire terminals 210 in the open position, the electrical wires 700 can be removed from the switch 10 and/or the switch 60.

The activating member 250 is described herein as moving in the directions of arrows “B” and “E” as shown in FIGS. 12 and 13. Movement of the activating member 250 shown in FIGS. 12 and 13 is a linear motion. While the activating member 250 is shown as moving linearly, the present disclosure contemplates other movement of the activating member 250. As non-limiting examples, movement of the activating member 250 can be rotational or torque motion, or movement of the activating member 250 may be pivotable motion, or movement of the activating member 250 can be a twisting motion. An example of rotational movement of the activating member is shown and described in commonly owned U.S. Pat. No. 11,495,895, which is incorporated herein in its entirety by reference. Movement of the activating member 250 may also be referenced relative to the wire terminal 210, or relative to components of the wire terminal 210, or to the housing 12. For example, the activating member 250 can move relative to the clamping member 214 or the clamp brace 212.

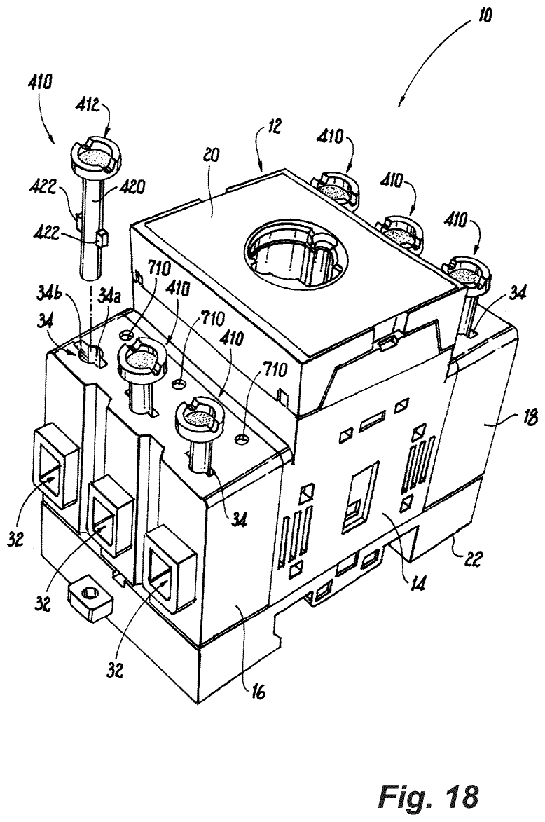

In the exemplary embodiments shown in FIGS. 18-31, 32-38, 39-49, 50-53, 54-57 and 58-61, the electrical wiring device may be a multi-pole switch, e.g., a three-pole switch. As set forth above, for ease of description, the multi-pole switch may also be referred to herein as the “switch” in the singular and the “switches” in the plural. The exemplary embodiments of FIGS. 18-31, 32-38, 39-49 and 50-53 also contemplate the inclusion of the auxiliary switches described herein and shown in FIGS. 6 and 7. The switches and auxiliary switches contemplated may be used to control the operation of multi-phase motors, e.g., three-phase motors.

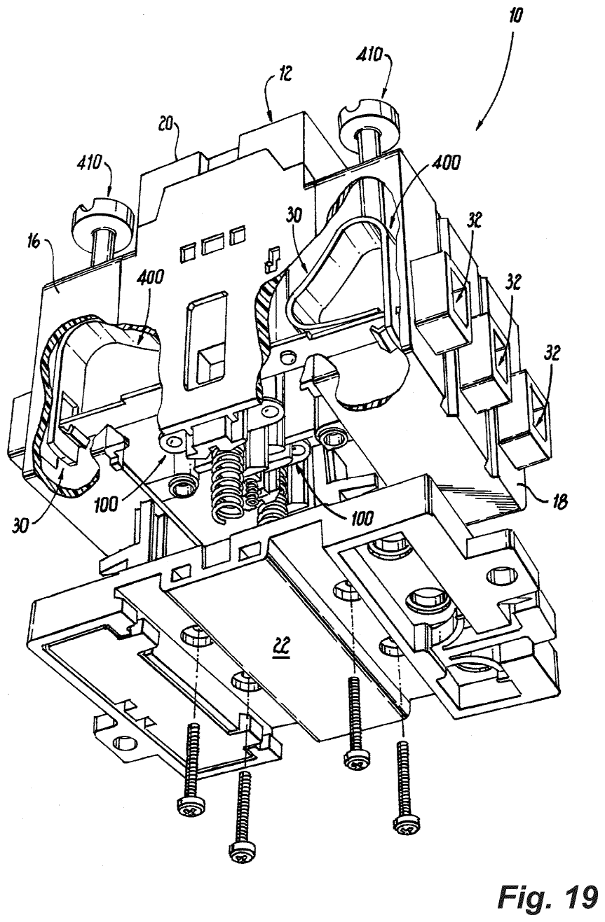

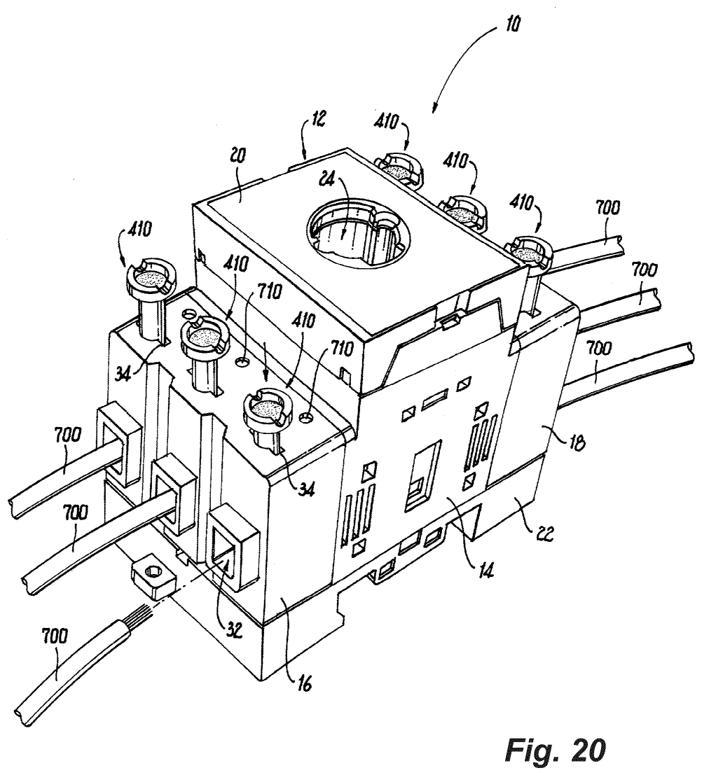

Referring now to FIGS. 18-31, another exemplary embodiment of a switch 10 according to the present disclosure is shown. The switch 10 includes similar features as described above for the embodiments of FIGS. 1-17 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. Within the main body portion 14 of the housing 12 are the components that perform the make and break functions of the switch 10. A non-limiting example of the components within the main body portion 14 that perform the make and break functions of the switch 10 are included in, for example, the HBLDS3RS Disconnect Switch sold by Hubbell Incorporated, which is incorporated herein in its entirety by reference. Generally, the main body portion 14 includes a plurality of spring loaded switch contacts 100, seen in FIGS. 3, 10, 19 and 27, that are accessible when the base 22 is removed from the housing 12. Each switch contact 100 acts as a jumper between corresponding pairs of wire termination assemblies 400 positioned at least partially within and accessible from the wire attachment portions 16 and 18. The top portion 20 of the housing 12 includes an on-off control assembly 24. The on-off control assembly 24 is operatively coupled to the switch contacts 100 such that the on-off control assembly 24 moves the switch contacts 100 between make and break positions. Each wire attachment portion 16 and 18 is secured to or integrally or monolithically formed into the main body portion 14. In the exemplary embodiment shown, each wire attachment portion 16 and 18 includes one or more wire termination chambers or cavities 30, seen in FIG. 19, one or more wire receiving openings 32 and one or more activating member openings 34, seen in FIGS. 18 and 20. Each wire termination chamber or cavity 30 is configured to receive and position a wire terminal assembly 400 within the wire attachment portion 16 or 18, as shown in FIG. 19. In this configuration, one of the one or more wire receiving openings 32 and one of the one or more activating member openings 34 provide access from an exterior of the housing to one of the one or more wire termination chambers or cavities 30. In the exemplary embodiment shown, each of the one or more activating member openings 34 includes a main portion 34a and one or more keyways 34b shown in FIG. 18.

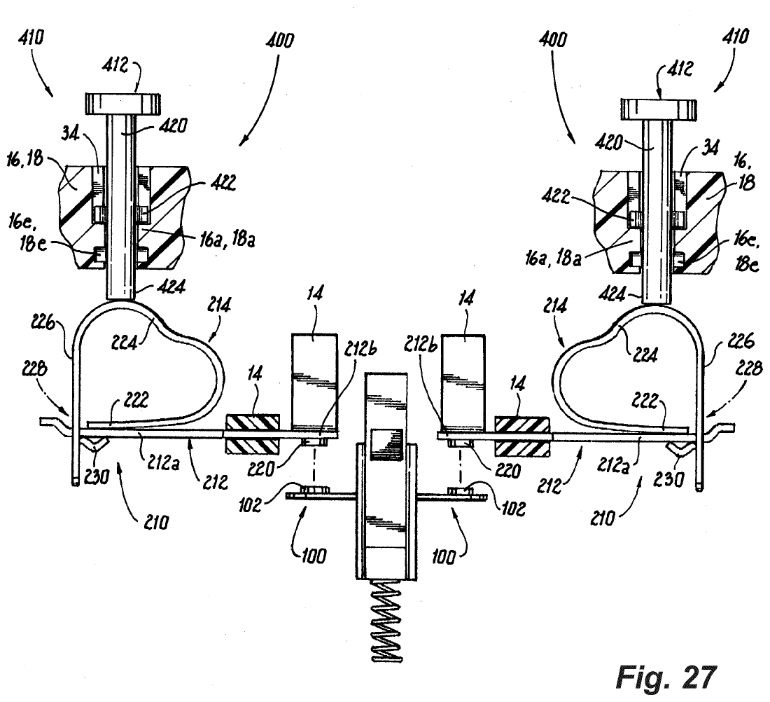

Continuing to refer to FIGS. 18-31, an exemplary embodiment of a wire termination assembly 400 according to the present disclosure is substantially similar to the wire termination assembly 200 described above, except that the one or more wire termination assemblies 400 are oriented within the wire attachment portions 16 and 18 such that the one or more activating member openings 34 extend through a top surface of the wire attachment portions 16 and 18, as shown in FIG. 18. Each wire termination assembly 400 is configured to receive and clamp a wire, such as wire 700 shown in FIG. 20, to the switch 10, and to mate with the switch contacts 100 of the switch 10, seen in FIG. 19. In the exemplary embodiment shown in FIGS. 27-31, the wire termination assembly 400 includes a wire terminal 210 and an activating member 410. The wire terminal 210 is at least partially made of an electrically conductive material, such as brass, copper or aluminum. In an exemplary embodiment, at least a portion of the wire terminal 210 is made of a resilient material with sufficient stiffness to flex when a mechanical load is applied and return to its normal position when the mechanical load is removed. An example of such a resilient material is spring steel. The wire terminal 210 is a mechanical clamping terminal that may use one or more clamping members 214 that can deflect under a mechanical load applied by the activating member 410 and recover to their initial shape when the mechanical load is removed. The energy stored by the one or more clamping members 214 should be sufficient to apply a constant and continuous force to mechanically secure one or more wires, e.g., wires 700 shown in FIG. 20, to the wire terminal 210. In the exemplary configuration shown in FIGS. 27-31, the wire terminal 210 includes a clamp brace 212 and a clamping member 214. The clamp brace 212 is an electrically conductive fixed terminal body that may be a substantially planar shaped member or an arcuate shaped member having a first end 212a secured to the clamping member 214. The clamp brace 212 may be secured to the clamping member 214 by, for example, mechanically fitting, e.g., clipping, the clamp brace 212 to the clamping member 214 or a solder joint, a brazed joint, or a welded joint. The clamping member 214 includes a brace contact member 222, a biasing member 224 and a clamp arm 226 as described above. The wire terminal 210 is the same as the wire terminal 210 described above and shown in FIGS. 8-13, such that a more detailed description thereof is not repeated.

As noted, the wire terminal 210 can connect to electrical conductors of different sizes. For example, if the electrical wiring device, e.g., switch 10, is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring device is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring device is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit. As another example, if the blade-type electrical receptacle is rated for 50 amps, then the wire terminal 210 should also be rated for at least 50 amps. The wire size, i.e., the bare conductor size, for 50 amps is 6 AWG wire such that the clamp arm 226 should be able to move to an open position where the outer diameter of 6 AWG wire can fit.

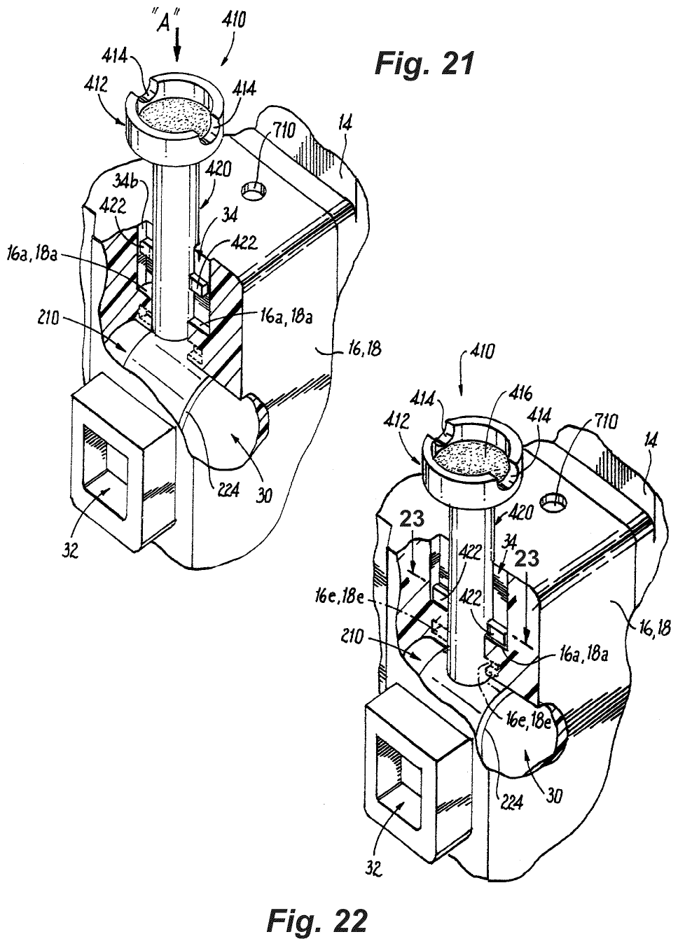

Referring to FIGS. 21-26, an exemplary embodiment of the activating member 410 is shown. In this exemplary embodiment, the activating member 410 is a pushbutton having a head 412 and a stem 420. The activating member 410 is preferably made of suitably rigid electrical insulating materials, such as plastic materials. Non-limiting examples of plastic materials include injection molded thermoplastic materials, such as Nylon. The activating member 410 may be an integrally or monolithically formed member or the activating member 410 may be separate components joined together by adhesives, welds or mechanical fasteners. In the exemplary embodiments shown, the activating member 410 is an integrally or monolithically formed member. The activating member 410 may also be referred to herein as a “pushbutton” in the singular and “pushbuttons” in the plural.

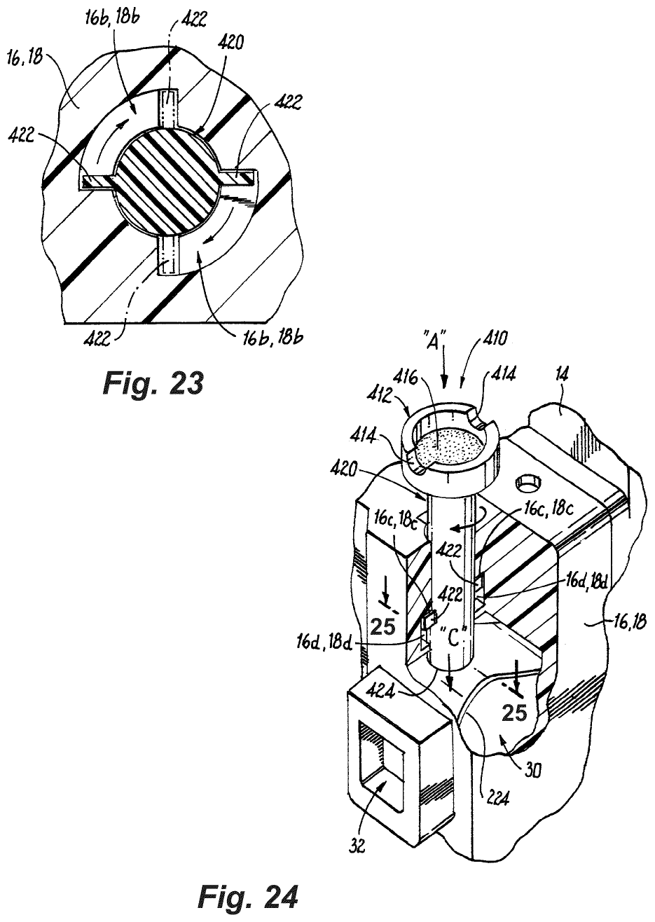

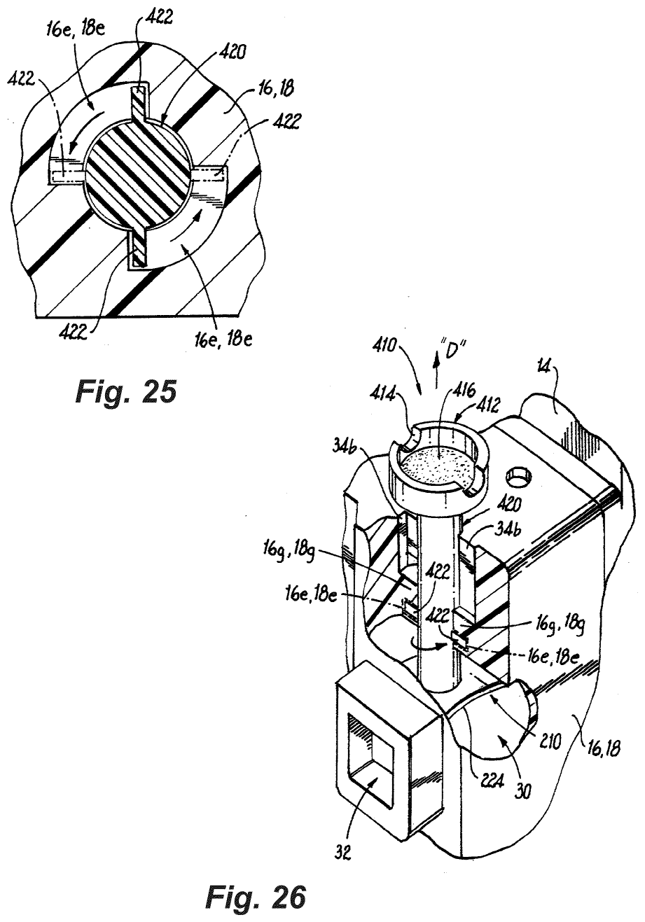

The head 412 of the pushbutton 410 is preferably dimensioned to be larger than the stem 420 so that the head 412 does not enter the activating member openings 34 in the wire attachment portions 16 and 18. The head 412 may be configured to provide grip enhancing features to help facilitate rotation of the pushbutton 410 when installing the pushbutton into the wire attachment portions 16 and 18, and when activating, e.g., moving, the clamping member 214 of the wire terminal 210 between closed and open positions, as described below. As an example, a grip enhancing feature may be notches, curved surfaces, ribs or other structures 414 in, on or extending from the head 412. Another example of a grip enhancing feature may be a textured surface 416 of the head 412. Non-limiting examples of textured surfaces 416 include coatings, striations, knurling and/or small narrow grooves on the head 412. The stem 420 of the pushbutton 410 is an elongated member configured to extend into and through one of the one or more activating member openings 34 into one of the one or more wire termination cavities 30. The stem 420 may be cylindrical structure with a circular cross-section, as shown in FIGS. 23 and 25. A non-limiting example of other shapes for the stem 420 structure include cuboid structures with a square or rectangular cross-sections. The stem 420 includes one or more pins or keys 422 extending from the stem 420 as shown. The one or more pins 422 in combination with channels in the wire attachment portions 16 and 18 form a bayonet like fastening structure which will be described below. In the embodiment shown, the pins 422 extend substantially perpendicular to a longitudinal axis of the stem 420. However, the pins 422 may extend at an angle relative to the longitudinal axis of the stem 420.

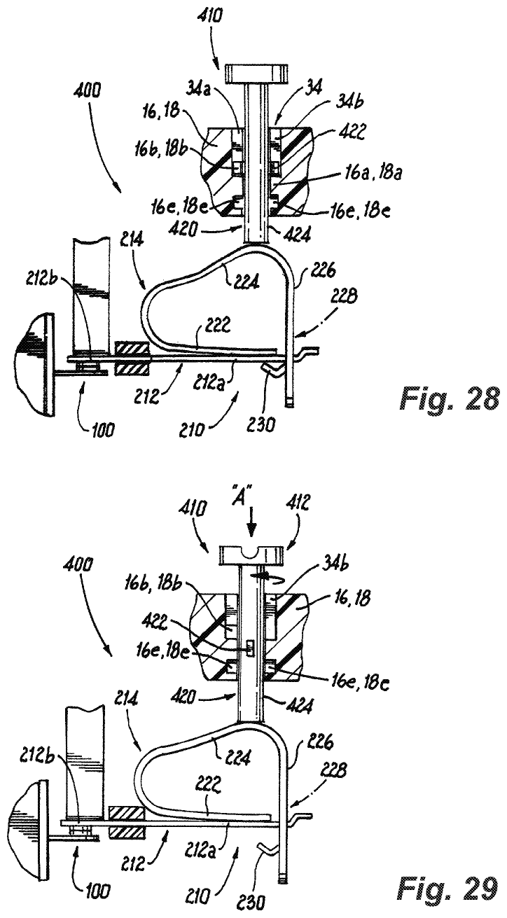

Continuing to refer to FIGS. 21-31, an exemplary embodiment of a use scenario for the switch 10 of FIGS. 14, 15 and 18-31 described herein is shown. In this exemplary embodiment, a 30 amp, three-phase electrical motor 300 is controlled by a disconnect switch assembly 310. The disconnect switch assembly 310 includes an electrical enclosure or electrical box 312 having a main body 314 and a removable cover 316. For ease of description, the electrical enclosure or electrical box 312 may also be referred to herein as the “enclosure” in the singular and the “enclosures” in the plural. The enclosure 312 may be a weatherproof or watertight enclosure. A switch 10 is secured in the main body 314 of the enclosure 312. As described herein, the switch 10 includes wire termination assemblies 400 to terminate electrical conductors or wires within the enclosure 312. The switch 10 is shipped with the pushbuttons 410 installed and locked within the wire attachment portions 16 and 18. To lock the pushbuttons 410 to respective wire attachment portions 16 and 18, the stem 420 and pins 422 of the pushbuttons 410 are first inserted into one of the activating member openings 34 so that the stem 420 can pass into the main portion 34a of the activating member opening 34, and pins 422 can pass into the keyways 34b in the activating member openings 34. The stem 420 and pins 422 are inserted into the activating member opening 34 until the pins 422 contact a ledge 16a, 18a of the respective activating member opening 34, as shown in FIGS. 21, 22, 30 and 31. The stem 420 is then rotated, e.g., rotated clockwise, by rotating the head 412 of the pushbutton 410, seen in FIGS. 23 and 29. One or more of the grip enhancing features 414 and 416 help the installer with rotating the pushbutton 410. When rotating the pushbutton 410, the pins 422 extending from the stem 420 rotate within locking channels 16b, 18b in the respective wire attachment portions 16 and 18, seen in FIGS. 23, 24 and 29. In this embodiment, the locking channels 16b, 18b are horizontal channels. The pins 422 are rotated in the locking channels 16b, 18b so that the pins 422 have solid portions 16c, 18c above the pins 422, as shown in FIG. 24. Preferably, the pins 422 are rotated about 90 degrees so that the pins 422 are aligned with the intermediate channels 16d, 18d in the respective wire attachment portions 16 and 18, seen in FIG. 24. In this position, the pins 422 and thus the pushbutton 410 are blocked from being withdrawn or removed from the activating member opening 34 of the respective wire attachment portions 16 and 18. As a result, the pushbuttons 410 are locked into the respective wire attachment portions 16 and 18 of the housing 12. Preferably, in the locked position the pins 422 of the pushbutton 410 are aligned with the intermediate channels 16d, 18d, as shown in FIGS. 24 and 29. In the embodiment shown, the intermediate channels 16d, 18d are vertical channels extending from the locking channels 16b, 18b to holding channels 16e, 18e. The holding channels are, in this embodiment, horizontal channels, as shown in FIGS. 28-31.

Continuing to refer to FIGS. 21-31, to connect wires 700 within the enclosure 312 to the switch 10, an installer, e.g., an electrician, first strips the insulation from the end of each wire. In the exemplary embodiment shown in FIGS. 14-15, the switch 10 is a three-pole switch that has six wire termination assemblies 400, such that six wires can be connected to the switch 10. The six wires include line side phase 1, phase 2 and phase 3 wires, and load side phase 1, phase 2 and phase 3 wires. However, it is also contemplated that each wire termination assemblies 400 could be configured to electrically connect more than one wire to the wire termination assemblies 400.

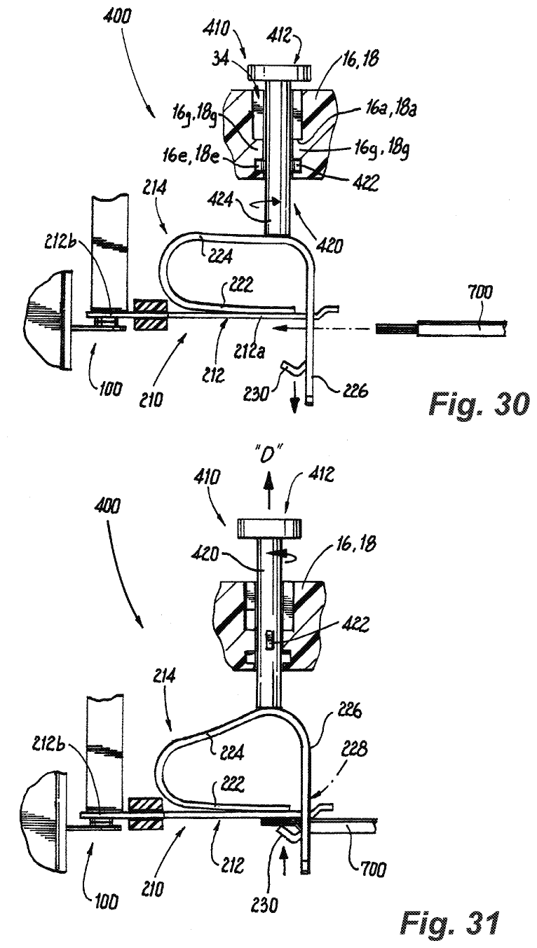

After the insulation is stripped from the end of each wire, the heads 412 of the pushbuttons 410 are pressed in the direction of arrow “A” so that the pins 422 move within the intermediate channels 16d, 18d, as shown in FIGS. 24 and 29. Moving the pushbutton 410 in the direction of arrow “A” causes the distal end 424 of the stem 420 of the pushbutton 410 to apply a mechanical load on the biasing member 224 of the clamping terminal 214. Applying a mechanical load on the biasing member 224, causes the biasing member 224 to deflect or move in the direction of arrow “C,” seen in FIGS. 24 and 30, from the closed position toward the open position. With the wire terminals 210 in the open position, the bare end of the electrical wires 700 are then inserted into the appropriate wire receiving openings 32 in the wire attachment portions 16 or 18 of the switch housing 12. The wire receiving openings 32 also guide the bare end of the wires 700 into the portion of the elongated opening 228 of the clamping member 214 between clamp brace 212 and wire press member 230. When the bare end of each wire 700 is positioned between the clamp brace 212 and the wire press member 230, the respective pushbutton 410 is released by the installer. Releasing the pushbutton 410 removes the mechanical load applied by the pushbutton 410 on the biasing member 224 so that the energy stored by the biasing member 224 moves the wire press member 230 in the direction of arrow “D” to the closed position with sufficient force to secure or clamp the wire 700 between the clamp brace 212 and the wire press member 230 completing an electrically conductive path between the wire 700 and the wire termination assembly 200. In addition, moving the biasing member 224 in the direction of arrow “D” returns the pushbutton 410 to the locking position, seen in FIG. 31.

In another exemplary embodiment, after the insulation is stripped from the end of each wire, the heads 412 of the pushbuttons 410 are pressed in the direction of arrow “A” so that the pins 422 move within the intermediate channels 16d, 18d, seen in FIG. 24. Moving the pushbutton 410 in the direction of arrow “A” causes the distal end 424 of the stem 420 of the pushbutton 410 to apply a mechanical load on the biasing member 224 of the clamping member 214. Applying a mechanical load on the biasing member 224, causes the biasing member 224 to deflect or move in the direction of arrow “C,” seen in FIGS. 24 and 30, from the closed position toward the open position. The installer can then rotate the head 412 of the pushbutton 410 in a counterclockwise direction so that the pins 422 of the pushbutton 410 move, e.g., rotate, within the holding channels 16e, 18e in the respective wire attachment portions 16 and 18, seen in FIGS. 25 and 30. The pins 422 are rotated within the holding channels 16e, 18e so that the pins 422 have solid portions 16g, 18g of the wire attachment portions 16 and 18 above the pins 422 as shown in FIGS. 26 and 30. Preferably, the pins 422 are rotated about 90 degrees. With the pins 422 rotated so that solid portions 16g, 18g are above the pins 422, the pins 422 and thus the pushbutton 410 are blocked from being withdrawn or removed from the wire attachment portions 16 and 18. In such a condition, the pushbuttons 410 are holding the respective wire terminals 210 in the open position, seen in FIG. 30. With the wire terminals 210 in the open position, the bare end of the electrical wires 700 are then inserted into the appropriate wire receiving openings 32 in the wire attachment portions 16 or 18 of the switch housing 12. The wire receiving openings 32 also guide the bare end of the wires 700 into the portion of the elongated opening 228 of the clamping member 214 between clamp brace 212 and wire press member 230. When the bare end of each wire 700 is positioned between the clamp brace 212 and the wire press member 230, the heads 412 of the respective pushbuttons 410 are moved, e.g., rotated, in a clockwise direction returning the pins 422 of the pushbuttons 410 into alignment with the intermediate channels 16d, 18d. With the pins 422 in alignment with the intermediate channels 16d, 18d, the installer can then release the pushbutton 410. Releasing the pushbutton 410 removes the mechanical load applied by the pushbutton 410 on the biasing member 224 of the clamping member 214 so that the energy stored by the biasing member 224 moves the wire press member 230 in the direction of arrow “D”, seen in FIGS. 25 and 31, to the closed position with sufficient force to secure or clamp the wire 700 between the clamp brace 212 and the wire press member 230 completing an electrically conductive path between the wire 700 and the wire termination assembly 400. In addition, moving the biasing member 224 in the direction of arrow “D” returns the pushbutton 410 to the locking position, seen in FIG. 31.

With the wires 700 connected to the switch 10 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 10 into engagement with the electrical contact pads 220 on the clamp brace 212 of the wire termination assemblies 200 completing an electrically conductive path from the wires 700 to the motor 300 turning the motor “on.”

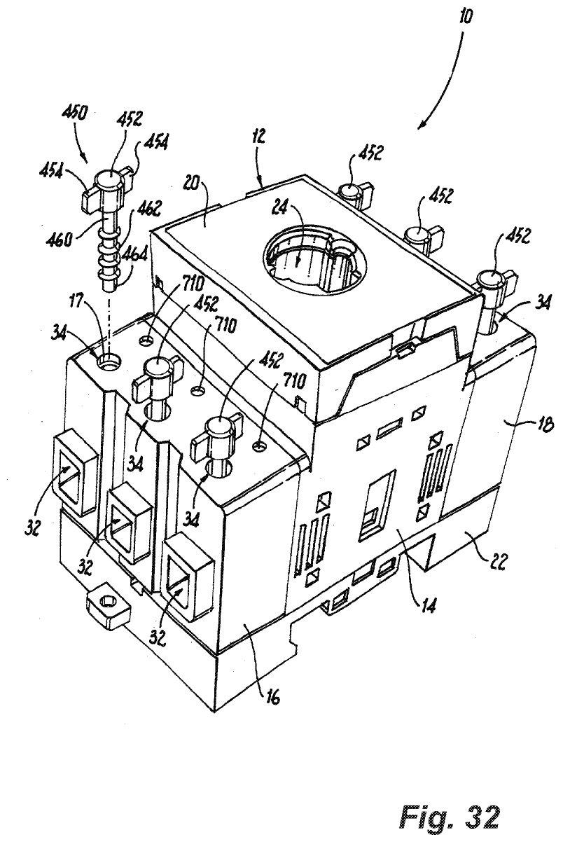

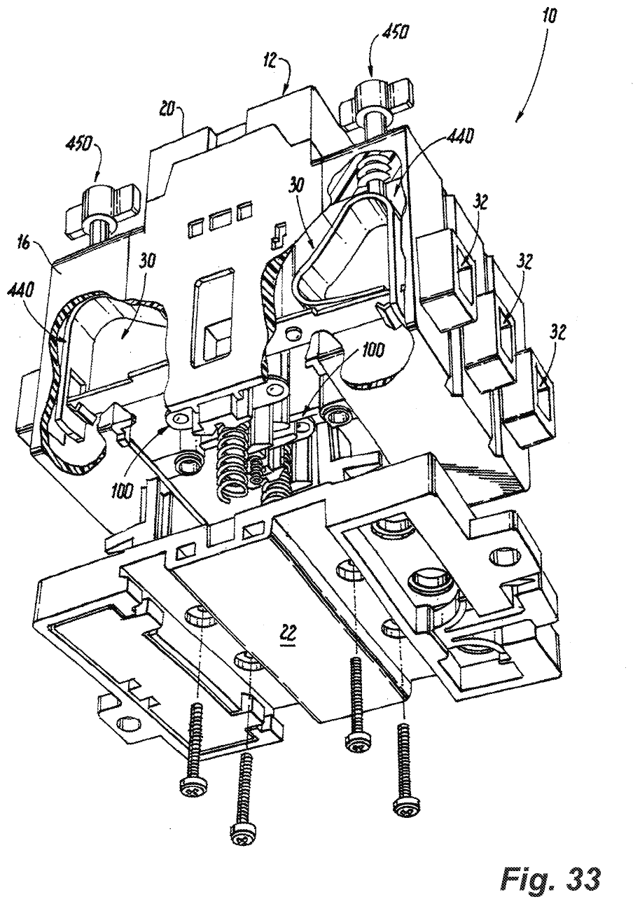

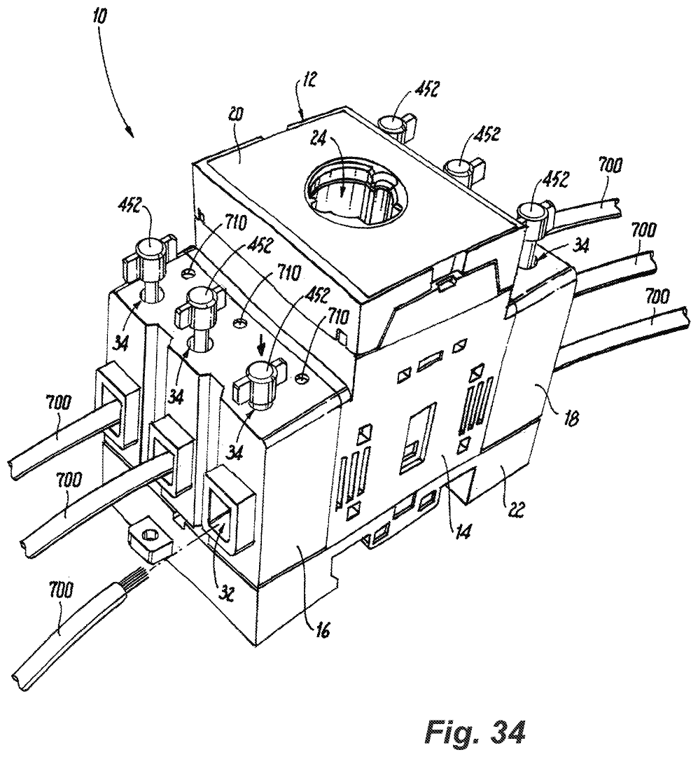

Referring now to FIGS. 32-38, another exemplary embodiment of a switch 10 according to the present disclosure is shown. The switch 10 includes similar features as described above for the embodiments of FIGS. 1-31 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. Within the main body portion 14 of the housing 12 are the components that perform the make and break functions of the switch 10. A non-limiting example of the components within the main body portion 14 that perform the make and break functions of the switch 10 are included in, for example, the HBLDS3RS Disconnect Switch sold by Hubbell Incorporated, which is incorporated herein in its entirety by reference. Generally, the main body portion 14 includes a plurality of spring loaded switch contacts 100, seen in FIGS. 3, 10, 33 and 35, that are accessible when the base 22 is removed from the housing 12. Each switch contact 100 acts as a jumper between corresponding pairs of wire termination assemblies 440 positioned at least partially within and accessible from the wire attachment portions 16 and 18. The top portion 20 of the housing 12 includes an on-off control assembly 24. The on-off control assembly 24 is operatively coupled to the switch contacts 100 such that the on-off control assembly 24 moves the switch contacts 100 between make and break positions. Each wire attachment portion 16 and 18 is secured to or integrally or monolithically formed into the main body portion 14. In the exemplary embodiment shown, each wire attachment portion 16 and 18 includes one or more wire termination chambers or cavities 30, seen in FIG. 33, one or more wire receiving openings 32 and one or more activating member openings 34, seen in FIGS. 32 and 34. Each wire termination chamber or cavity 30 is configured to receive and position a wire termination assembly 440 within the wire attachment portion 16 or 18, as shown in FIG. 33. In this configuration, one of the one or more wire receiving openings 32 and one of the one or more activating member openings 34 provide access from an exterior of the housing to one of the one or more wire termination chambers or cavities 30.

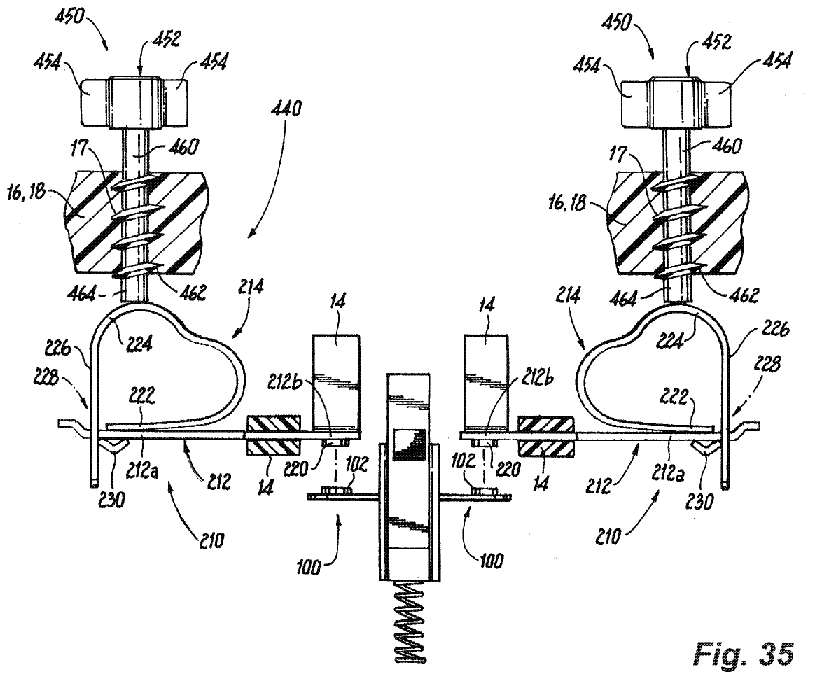

Continuing to refer to FIGS. 32-38, an exemplary embodiment of a wire termination assembly 440 according to the present disclosure is substantially similar to the wire termination assembly 200 described above, except that the one or more wire termination assemblies 440 are oriented within the wire attachment portions 16 and 18 such that the one or more activating member openings 34 extend through a top surface of the wire attachment portions 16 and 18, as shown in FIGS. 32 and 34. Each wire termination assembly 440 is configured to receive and clamp a wire, such as wire 700 shown in FIG. 34, to the switch 10, and to mate with the switch contacts 100 of the switch 10, seen in FIG. 33. In the exemplary embodiment shown, the wire termination assembly 440 includes a wire terminal 210 and an activating member 450. The wire terminal 210 is at least partially made of an electrically conductive material, such as brass, copper or aluminum. In an exemplary embodiment, at least a portion of the wire terminal 210 is made of a resilient material with sufficient stiffness to flex when a mechanical load is applied and return to its normal position when the mechanical load is removed. An example of such a resilient material is spring steel. The wire terminal 210 is a mechanical clamping terminal that may use one or more clamping members 214 that can deflect under a mechanical load applied by the activating member 450 and recover to their initial shape when the mechanical load is removed. The energy stored by the one or more clamping members 214 should be sufficient to apply a constant and continuous force to mechanically secure one or more wires, e.g., wires 700 shown in FIG. 34, to the wire terminal 210. In the exemplary configuration shown in FIGS. 35-38, the wire terminal 210 includes a clamp brace 212 and a clamping member 214. The clamp brace 212 is an electrically conductive fixed terminal body that may be a substantially planar shaped member or an arcuate shaped member having a first end 212a secured to the clamping member 214. The clamp brace 212 may be secured to the clamping member 214 by, for example, mechanically fitting, e.g., clipping, the clamp brace 212 to the clamping member 214 or a solder joint, a brazed joint, or a welded joint. The clamping member 214 includes a brace contact member 222, a biasing member 224 and a clamp arm 226 as described above. The wire terminal 210 is the same as the wire terminal 210 described above and shown in FIGS. 8-13, such that a more detailed description thereof is not repeated.

As noted, the wire terminal 210 can connect to electrical conductors of different sizes. For example, if the electrical wiring device, e.g., switch 10, is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring device is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring device is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit. As another example, if the blade-type electrical receptacle is rated for 50 amps, then the wire terminal 210 should also be rated for at least 50 amps. The wire size, i.e., the bare conductor size, for 50 amps is 6 AWG wire such that the clamp arm 226 should be able to move to an open position where the outer diameter of 6 AWG wire can fit.

Referring to FIGS. 35-38, an exemplary embodiment of the activating member 450 is shown. In this exemplary embodiment, the activating member 450 is a threaded member having a head 452 and a stem 460. The activating member 450 is preferably made of suitably rigid electrical insulating materials, such as plastic materials. Non-limiting examples of plastic materials include injection molded thermoplastic materials, such as Nylon. The activating member 450 may be an integrally or monolithically formed member or the activating member 450 may be separate components joined together by adhesives, welds or mechanical fasteners. In the exemplary embodiments shown, the activating member 450 is an integrally or monolithically formed member.

The head 452 of the activating member 450 is preferably dimensioned to be larger than the stem 460 so that the head 452 does not enter the activating member openings 34 in the wire attachment portions 16 and 18. The head 452 may be configured to provide grip enhancing features to help facilitate rotation of the activating member 450 when installing the activating member 450 into the wire attachment portions 16 and 18, and when activating, e.g., moving, the clamping member 214 of the wire terminal 210 between closed and open positions, as described below. As an example, a grip enhancing feature may be fins, pads or other structures 454 in, on or extending from the head 452. Another example of a grip enhancing feature may be a textured surface on the fins, pads or other structures 454. Non-limiting examples of textured surfaces 416 include coatings, striations, knurling and/or small narrow grooves. The stem 460 of the activating member 450 is an elongated member configured to extend into and through one of the one or more activating member openings 34 into one of the one or more wire termination cavities 30. The stem 460 may be cylindrical structure with a circular cross-section, as shown in FIGS. 35-38. The stem 460 includes threading 462 along at least a portion of the perimeter of the stem as shown. The threading 462 in the embodiment shown is coarse threading. However, the present disclosure contemplates other types of threading, such as fine threading. The threading 462 is configured to ride within a track 17 in the wire attachment portions 16 and 18, as shown in FIGS. 35-38. The track 17 may be threading within the wire attachment portions 16 and 18 that corresponds to the threading 462. Having the threading 462 of the stem 460 ride within the track 17 translates rotational motion of the head 452 to linear motion of the stem 460. In another exemplary embodiment, instead of threading, the stem 460 may include one or more pins (not shown) that ride within the track 17. In this exemplary embodiment, the track 17 would be a continuous helical track configured and dimensioned to receive the one or more pins (not shown) so that the pins could ride along the track 17 as the head 452 is rotated. Having the pins ride within the track 17 translates rotational motion of the head 452 to linear motion of the stem 460.

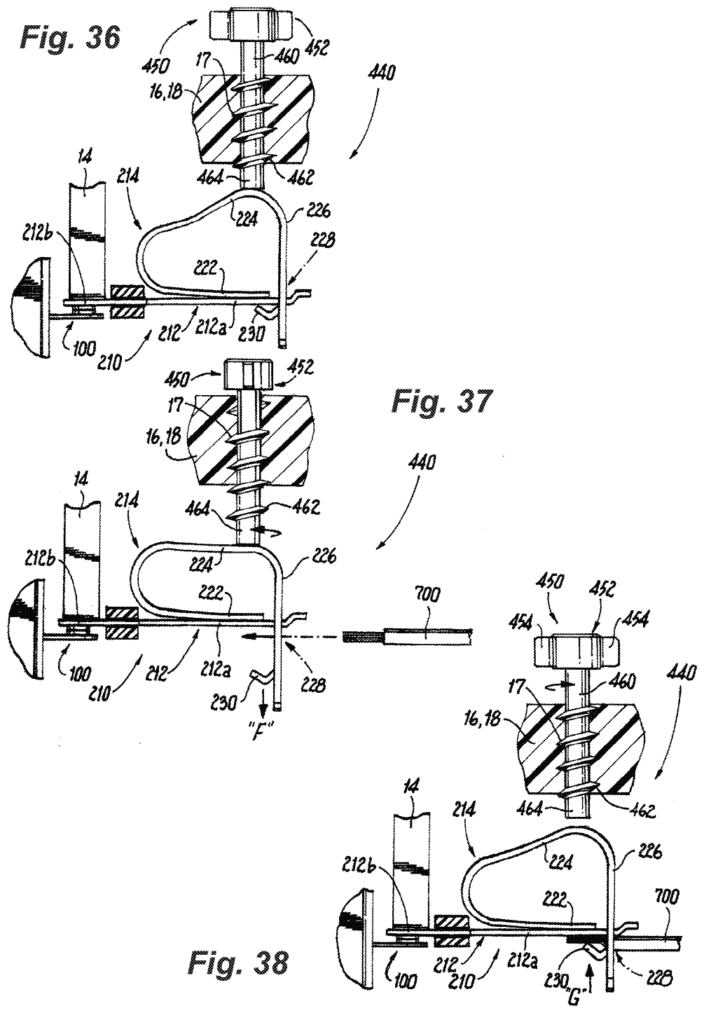

In the exemplary embodiments described herein, linear motion of the stem 460 in a first direction causes a distal end 464 of the stem 460 to apply a mechanical load to the biasing member 224 of the clamping members 214 deflecting the biasing member 224 so as to move the wire terminal 210 from the closed position, seen in FIG. 36, to the open position, seen in FIG. 37. Linear motion of the stem 460 in a second direction removes the mechanical load on the biasing member 224 so that the wire terminal 210 permitting the wire terminal 210 to return or recover from the open position to the closed position until the biasing member 224 is in its initial shape, as shown in FIG. 38.

Continuing to refer to FIGS. 35-38, an exemplary embodiment of a use scenario for the switch 10 of FIGS. 14, 15 and 32-38 described herein is shown. In this exemplary embodiment, a 30 amp, three-phase electrical motor 300 is controlled by a disconnect switch assembly 310. The disconnect switch assembly 310 includes an electrical enclosure or electrical box 312 having a main body 314 and a removable cover 316. For ease of description, the electrical enclosure or electrical box 312 may also be referred to herein as the “enclosure” in the singular and the “enclosures” in the plural. The enclosure 312 may be a weatherproof or watertight enclosure. A switch 10 is secured in the main body 314 of the enclosure 312. As described herein, the switch 10 includes wire termination assemblies 440 to terminate electrical conductors or wires within the enclosure 312. The switch 10 is shipped with the activating member 450 installed in the activating member openings 34 within the wire attachment portions 16 and 18. To connect wires 700 within the enclosure 312 to the switch 10, an installer, e.g., an electrician, first strips the insulation from the end of each wire. In the exemplary embodiment shown in FIGS. 14-15, the switch 10 is a three-pole switch that has six wire termination assemblies 440, such that six wires can be connected to the switch 10. The six wires include line side phase 1, phase 2 and phase 3 wires, and load side phase 1, phase 2 and phase 3 wires. However, it is also contemplated that each wire termination assemblies 440 could be configured to electrically connect more than one wire to the wire termination assemblies 440.

After the insulation is stripped from the end of each wire, the heads 452 of the activating member 450 are rotated, e.g., rotated clockwise, so that the distal end 464 of the stem 460 of the activating member 450 applies a mechanical load on the biasing member 224 of the clamping member 214. Applying a mechanical load on the biasing member 224 causes the biasing member 224 to deflect or move in the direction of arrow “F” seen in FIG. 37, from the closed position toward the open position. With the wire terminals 210 in the open position, the bare end of the electrical wires 700 are then inserted into the appropriate wire receiving openings 32 in the wire attachment portions 16 or 18 of the switch housing 12, seen in FIGS. 32-34. The wire receiving openings 32 also guide the bare end of the wires 700 into the portion of the elongated opening 228 of the clamping member 214 between clamp brace 212 and wire press member 230, as shown in FIG. 37. When the bare end of each wire 700 is positioned between the clamp brace 212 and the wire press member 230, the respective activating member 450 is rotated, rotated counterclockwise, by the installer. Rotating the activating member 450 removes the mechanical load applied distal end 464 of the stem 460 on the biasing member 224 so that the energy stored by the biasing member 224 moves the wire press member 230 in the direction of arrow “G” to the closed position with sufficient force to secure or clamp the wire 700 between the clamp brace 212 and the wire press member 230 completing an electrically conductive path between the wire 700 and the wire termination assembly 200, as shown in FIG. 38.

With the wires 700 connected to the switch 10 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 10 into engagement with the electrical contact pads 220 on the clamp brace 212 of the wire termination assemblies 200 completing an electrically conductive path from the wires 700 to the motor 300 turning the motor “on.”

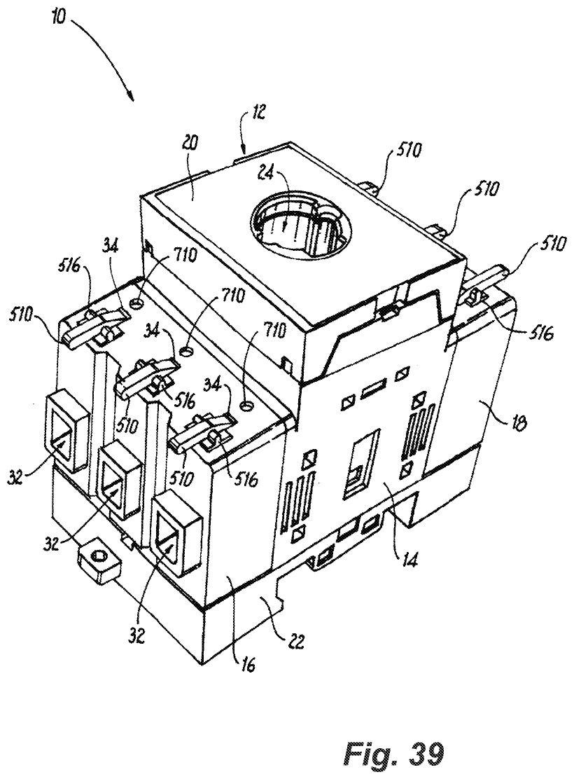

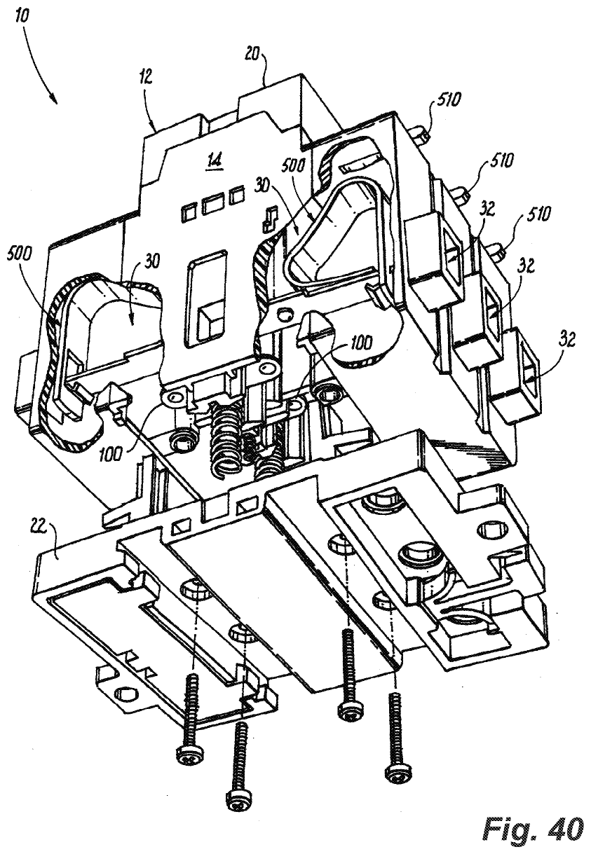

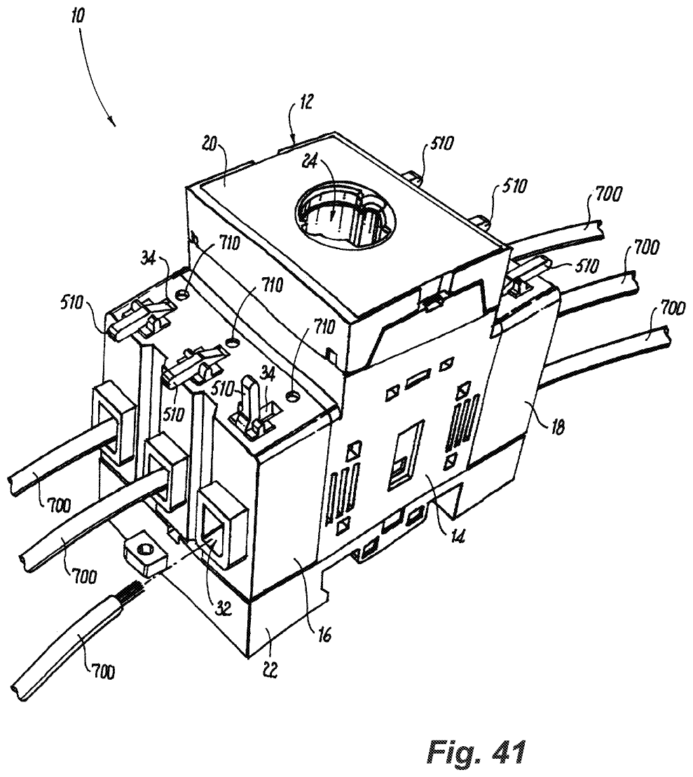

Referring now to FIGS. 39-45, another exemplary embodiment of a switch 10 according to the present disclosure is shown. The switch 10 includes similar features as described above for the embodiments of FIGS. 1-38 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. Within the main body portion 14 of the housing 12 are the components that perform the make and break functions of the switch 10. A non-limiting example of the components within the main body portion 14 that perform the make and break functions of the switch 10 are included in, for example, the HBLDS3RS Disconnect Switch sold by Hubbell Incorporated, which is incorporated herein in its entirety by reference. Generally, the main body portion 14 includes a plurality of spring loaded switch contacts 100, seen in FIGS. 3, 10, 40 and 42, that are accessible when the base 22 is removed from the housing 12. Each switch contact 100 acts as a jumper between corresponding pairs of wire termination assemblies 500 positioned at least partially within and accessible from the wire attachment portions 16 and 18. The top portion 20 of the housing 12 includes an on-off control assembly 24. The on-off control assembly 24 is operatively coupled to the switch contacts 100 such that the on-off control assembly 24 moves the switch contacts 100 between make and break positions. Each wire attachment portion 16 and 18 is secured to or integrally or monolithically formed into the main body portion 14. In the exemplary embodiment shown, each wire attachment portion 16 and 18 includes one or more wire termination chambers or cavities 30, seen in FIG. 40, one or more wire receiving openings 32 and one or more activating member openings 34, seen in FIGS. 39 and 41. Each wire termination chamber or cavity 30 is configured to receive and position a wire terminal assembly 510 within the wire attachment portion 16 or 18, as shown in FIG. 40. In this configuration, one of the one or more wire receiving openings 32 and one of the one or more activating member openings 34 provide access from an exterior of the housing to one of the one or more wire termination chambers or cavities 30.

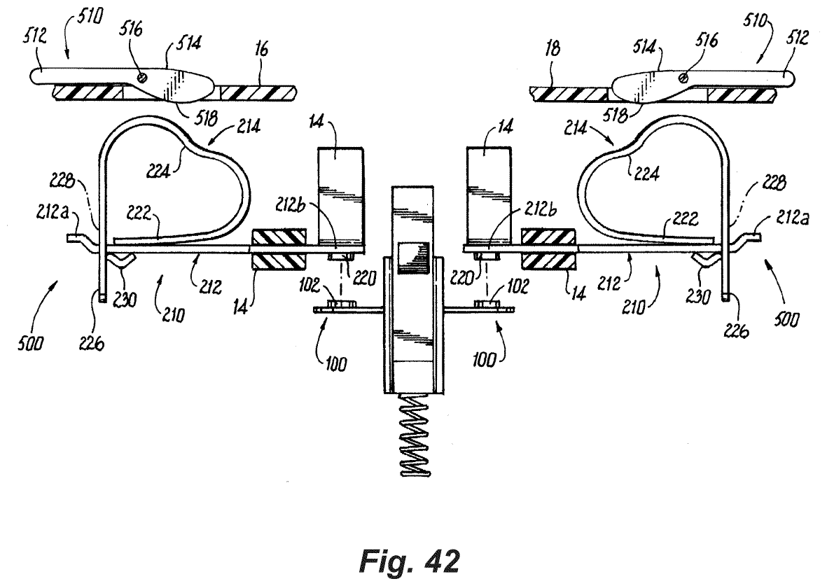

Continuing to refer to FIGS. 39-45, an exemplary embodiment of a wire termination assembly 500 according to the present disclosure is substantially similar to the wire termination assembly 200 described above, except that the one or more wire termination assemblies 500 are oriented within the wire attachment portions 16 and 18 such that the one or more activating member openings 34 extend through a top surface of the wire attachment portions 16 and 18, as shown in FIGS. 39 and 41. Each wire termination assembly 500 is configured to receive and clamp a wire, such as wire 700 shown in FIG. 41, to the switch 10, and to mate with the switch contacts 100 of the switch 10, seen in FIG. 42. In the exemplary embodiment shown, the wire termination assembly 500 includes a wire terminal 210 and an activating member 510. The wire terminal 210 is at least partially made of an electrically conductive material, such as brass, copper or aluminum. In an exemplary embodiment, at least a portion of the wire terminal 210 is made of a resilient material with sufficient stiffness to flex when a mechanical load is applied and return to its normal position when the mechanical load is removed. An example of such a resilient material is spring steel. The wire terminal 210 is a mechanical clamping terminal that may use one or more clamping members 214 that can deflect under a mechanical load applied by the activating member 510 and recover to their initial shape when the mechanical load is removed. The energy stored by the one or more clamping members 214 should be sufficient to apply a constant and continuous force to mechanically secure one or more wires, e.g., wires 700 shown in FIG. 41, to the wire terminal 210. Referring to FIGS. 42-45, the wire terminal 210 includes a clamp brace 212 and a clamping member 214. The clamp brace 212 is an electrically conductive fixed terminal body that may be a substantially planar shaped member or an arcuate shaped member having a first end 212a secured to the clamping member 214. The clamp brace 212 may be secured to the clamping member 214 by, for example, mechanically fitting, e.g., clipping, the clamp brace 212 to the clamping member 214 or a solder joint, a brazed joint, or a welded joint. The clamping member 214 includes a brace contact member 222, a biasing member 224 and a clamp arm 226 as described above. The wire terminal 210 is the same as the wire terminal 210 described above and shown in FIGS. 8-13, such that a more detailed description thereof is not repeated.

As noted, the wire terminal 210 can connect to electrical conductors of different sizes. For example, if the electrical wiring device, e.g., switch 10, is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring device is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring device is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit. As another example, if the blade-type electrical receptacle is rated for 50 amps, then the wire terminal 210 should also be rated for at least 50 amps. The wire size, i.e., the bare conductor size, for 50 amps is 6 AWG wire such that the clamp arm 226 should be able to move to an open position where the outer diameter of 6 AWG wire can fit.

Referring to FIGS. 42-45, an exemplary embodiment of the activating member 510 is shown. In this exemplary embodiment, the activating member 510 is a flip-lever having an input arm portion 512, a load arm portion 514 and a fulcrum 516 between the input arm portion 512 and the load arm portion 514. The activating member 510 is preferably made of suitably rigid electrical insulating materials, such as plastic materials. Non-limiting examples of plastic materials include injection molded thermoplastic materials, such as Nylon. The activating member 510 may be an integrally or monolithically formed member or the activating member 510 may be separate components joined together by adhesives, welds or mechanical fasteners. In the exemplary embodiments shown, the activating member 510 is an integrally or monolithically formed member. The activating member 510 may also be referred to herein as a “flip-lever” in the singular and “flip-levers” in the plural.

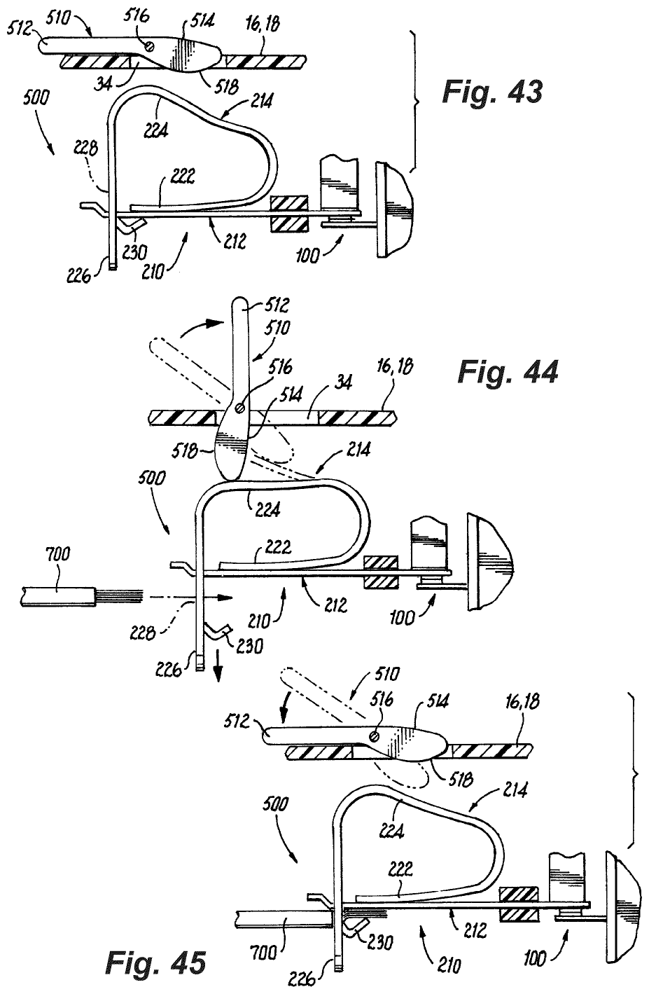

The input arm portion 512 of the flip-lever 510 is an elongated member that is preferably dimensioned to be larger in length than the load arm portion 514. The input arm portion 512 is configured and dimensioned so that a technician can rotate the input arm portion 512 about the fulcrum 516. In addition, the input arm portion 512 may have any shape that is suitable to be gripped by the technician. In the exemplary embodiment shown, the input arm portion 512 is a rectangularly shaped member extending from the fulcrum 516. The load arm portion 514 of the flip-lever 510 is configured and dimensioned to engage the biasing member 224 of the clamping member 214 when the input arm portion 512 is pivoted about the fulcrum 516 to translate pivotable motion of the flip-lever 510 to linear motion of the clamp arm 226 of the clamping member 214, as shown in FIG. 44. In the exemplary embodiment shown, the load arm portion 514 is configured to have an arcuate camming surface 518 that engages the biasing member 224 of the clamping member 214 when the input arm portion 512 is pivoted about the fulcrum 516. The arcuate camming surface 518 is configured and dimensioned to apply a mechanical load to the biasing member 224 deflecting the biasing member 224 so as to move the wire terminal 210 from the closed position, seen in FIG. 43, to the open position, seen in FIG. 44.

Continuing to refer to FIGS. 42-45, an exemplary embodiment of a use scenario for the switch 10 of FIGS. 14, 15 and 39-45 described herein is shown. In this exemplary embodiment, a 30 amp, three-phase electrical motor 300 is controlled by a disconnect switch assembly 310. The disconnect switch assembly 310 includes an electrical enclosure or electrical box 312 having a main body 314 and a removable cover 316. For ease of description, the electrical enclosure or electrical box 312 may also be referred to herein as the “enclosure” in the singular and the “enclosures” in the plural. The enclosure 312 may be a weatherproof or watertight enclosure. A switch 10 is secured in the main body 314 of the enclosure 312. As described herein, the switch 10 includes wire termination assemblies 500 to terminate electrical conductors or wires within the enclosure 312. The switch 10 is shipped with the activating member 450 installed at least partially in the activating member openings 34 within the wire attachment portions 16 and 18. To connect wires 700 within the enclosure 312 to the switch 10, an installer, e.g., an electrician, first strips the insulation from the end of each wire. In the exemplary embodiment shown in FIGS. 14-15, the switch 10 is a three-pole switch that has six wire termination assemblies 500, such that six wires can be connected to the switch 10. The six wires include line side phase 1, phase 2 and phase 3 wires, and load side phase 1, phase 2 and phase 3 wires. However, it is also contemplated that each wire termination assemblies 500 could be configured to electrically connect more than one wire to the wire termination assemblies 500.

After the insulation is stripped from the end of each wire, the input arm portion 512 of the flip-levers 510 are pivoted away from the exterior top surface of the wire attachment portions 16 or 18 of the switch housing 12 so that the input arm portion 512 is substantially perpendicular to the exterior top surface of the wire attachment portions 16 or 18, as shown in FIGS. 43 and 44. As the input arm portion 512 of the flip-levers 510 are pivoted, the camming surface 518 of the load arm portion 514 engages the biasing member 224 of the clamping member 214 and rides along the biasing member 224 applying a mechanical load on the biasing member 224. Applying a mechanical load on the biasing member 224 causes the biasing member 224 to deflect or move in the direction of arrow “H” seen in FIG. 44, from the closed position toward the open position. With the wire terminals 210 in the open position, the bare end of the electrical wires 700 are then inserted into the appropriate wire receiving openings 32 in the wire attachment portions 16 or 18 of the switch housing 12, seen in FIGS. 39-41. The wire receiving openings 32 also guide the bare end of the wires 700 into the portion of the elongated opening 228 of the clamping member 214 between clamp brace 212 and wire press member 230, as shown in FIG. 44. When the bare end of each wire 700 is positioned between the clamp brace 212 and the wire press member 230, the respective flip-lever 510 is pivoted back toward the original starting position of the flip-lever 510 as shown in FIG. 45. Pivoting the flip-lever 510 removes the mechanical load applied on the biasing member 224 so that the energy stored by the biasing member 224 moves the wire press member 230 in the direction of arrow “I” to the closed position with sufficient force to secure or clamp the wire 700 between the clamp brace 212 and the wire press member 230 completing an electrically conductive path between the wire 700 and the wire termination assembly 500, as shown in FIG. 45.

With the wires 700 connected to the switch 10 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 10 into engagement with the electrical contact pads 220 on the clamp brace 212 of the wire termination assemblies 200 completing an electrically conductive path from the wires 700 to the motor 300 turning the motor “on.”

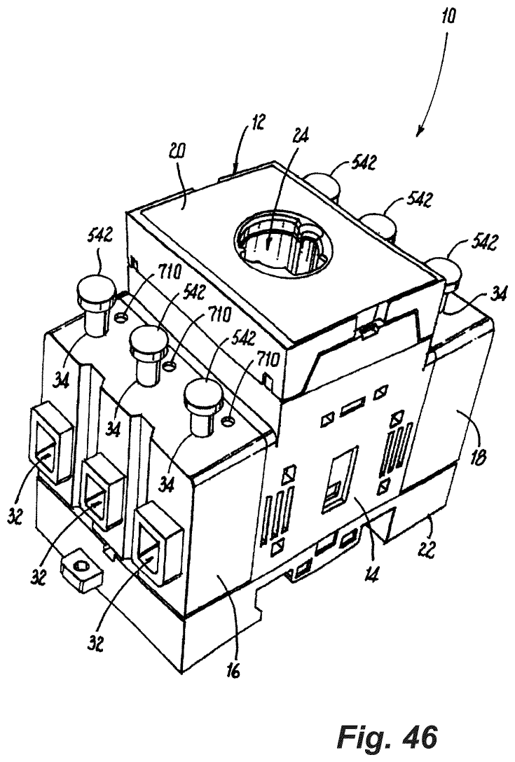

Referring now to FIGS. 46-49, another exemplary embodiment of a switch 10 according to the present disclosure is shown. The switch 10 includes similar features as described above for the embodiments of FIGS. 1-45 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. Within the main body portion 14 of the housing 12 are the components that perform the make and break functions of the switch 10. A non-limiting example of the components within the main body portion 14 that perform the make and break functions of the switch 10 are included in, for example, the HBLDS3RS Disconnect Switch sold by Hubbell Incorporated, which is incorporated herein in its entirety by reference. Generally, the main body portion 14 includes a plurality of spring loaded switch contacts 100, seen in FIGS. 3, 10, 47-49, that are accessible when the base 22 is removed from the housing 12. Each switch contact 100 acts as a jumper between corresponding pairs of wire termination assemblies 530 positioned at least partially within and accessible from the wire attachment portions 16 and 18. The top portion 20 of the housing 12 includes an on-off control assembly 24. The on-off control assembly 24 is operatively coupled to the switch contacts 100 such that the on-off control assembly 24 moves the switch contacts 100 between make and break positions. Each wire attachment portion 16 and 18 is secured to or integrally or monolithically formed into the main body portion 14. In the exemplary embodiment shown, each wire attachment portion 16 and 18 includes one or more wire termination chambers or cavities 30, similar to the cavities seen in FIG. 40, one or more wire receiving openings 32 and one or more activating member openings 34, seen in FIG. 46. Each wire termination chamber or cavity 30 is configured to receive and position a wire terminal assembly 530 within the wire attachment portion 16 or 18, similar to that shown in FIG. 40. In this configuration, one of the one or more wire receiving openings 32 and one of the one or more activating member openings 34 provide access from an exterior of the housing to one of the one or more wire termination chambers or cavities 30.

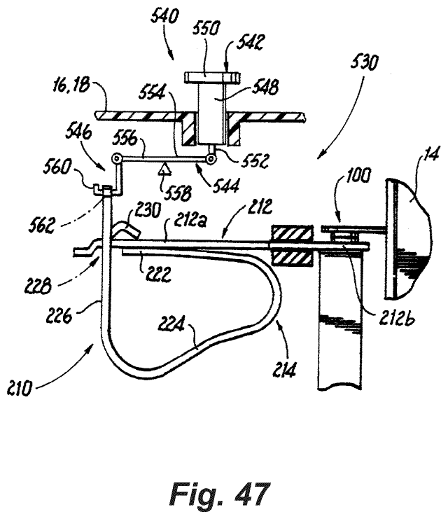

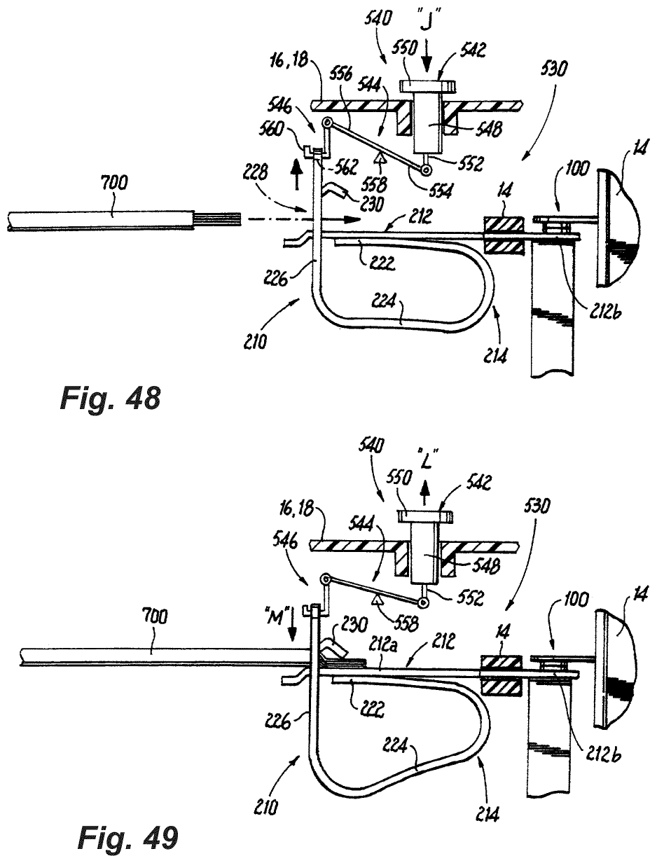

Continuing to refer to FIGS. 46-49, an exemplary embodiment of a wire termination assembly 530 according to the present disclosure is substantially similar to the wire termination assembly 200 described above, except that the one or more wire termination assemblies 530 are oriented within the wire attachment portions 16 and 18 such that the one or more activating member openings 34 extend through a top surface of the wire attachment portions 16 and 18, as shown in FIG. 46. Each wire termination assembly 530 is configured to receive and clamp a wire, such as wire 700 shown in FIG. 48, to the switch 10, and to mate with the switch contacts 100 of the switch 10, similar to that seen in FIG. 42. In the exemplary embodiment shown, the wire termination assembly 530 includes a wire terminal 210 and an activating assembly 540. The wire terminal 210 is at least partially made of an electrically conductive material, such as brass, copper or aluminum. In an exemplary embodiment, at least a portion of the wire terminal 210 is made of a resilient material with sufficient stiffness to flex when a mechanical load is applied and return to its normal position when the mechanical load is removed. An example of such a resilient material is spring steel. The wire terminal 210 is a mechanical clamping terminal that may use one or more clamping members 214 that can deflect under a mechanical load applied by the activating assembly 540 and recover to their initial shape when the mechanical load is removed. The energy stored by the one or more clamping members 214 should be sufficient to apply a constant and continuous force to mechanically secure one or more wires, e.g., wires 700 shown in FIG. 49, to the wire terminal 210. Referring to FIGS. 47-49, the wire terminal 210 includes a clamp brace 212 and a clamping member 214. The clamp brace 212 is an electrically conductive fixed terminal body that may be a substantially planar shaped member or an arcuate shaped member having a first end 212a secured to the clamping member 214. The clamp brace 212 may be secured to the clamping member 214 by, for example, mechanically fitting, e.g., clipping, the clamp brace 212 to the clamping member 214 or a solder joint, a brazed joint, or a welded joint. The clamping member 214 includes a brace contact member 222, a biasing member 224 and a clamp arm 226 as described above. The wire terminal 210 is the same as the wire terminal 210 described above and shown in FIGS. 8-13, such that a more detailed description thereof is not repeated.

As noted, the wire terminal 210 can connect to electrical conductors of different sizes. For example, if the electrical wiring device, e.g., switch 10, is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring device is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring device is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit. As another example, if the blade-type electrical receptacle is rated for 50 amps, then the wire terminal 210 should also be rated for at least 50 amps. The wire size, i.e., the bare conductor size, for 50 amps is 6 AWG wire such that the clamp arm 226 should be able to move to an open position where the outer diameter of 6 AWG wire can fit.

Referring again to FIGS. 47-49, an exemplary embodiment of the activating assembly 540 is shown. In this exemplary embodiment, the activating assembly 540 is a push-lever having a pushbutton 542, a lever 544 and a capture arm 546. The pushbutton 542 has a stem 548 and a head 550 at a first end of the stem 548. In this exemplary embodiment, the stem 548 is a cylindrical member having a circular cross-section that is configured and dimensioned to fit within the activating member opening 34 and pass into the wire termination cavity 30, such that the stem 548 is movable in the activating member opening 34. The head 550 is a cylindrical member having a circular cross-section with a diameter that is larger than the diameter of the stem 548 so that the head 550 does not fit in the activating member opening 34. A second end of the stem 548 has a connecting pin 552 that couples the pushbutton 542 to the lever 544. The lever 544 has an input arm portion 554, a load arm portion 556 and a fulcrum 558 positioned between the input arm portion 554 and the load arm portion 556. The input arm portion 554 is coupled to the connecting pin 552 to couple the pushbutton 542 to the lever 544. The load arm portion 556 is coupled to a first end of the capture arm 546. A second end of the capture arm 556 includes a coupling member 560 used to couple the capture arm 556 to the clamp arm 226 of the clamping member 214. For example, the coupling member 560 may be a hook like structure that fits within an aperture 562 in the clamp arm 226 of the clamping member 214. The activating assembly 540 is preferably made at least partially of suitably rigid electrical insulating materials, such as plastic materials. Non-limiting examples of plastic materials include injection molded thermoplastic materials, such as Nylon. In the configuration shown, when the pushbutton 542 is pushed in the direction of arrow “J,” seen in FIG. 48, the lever 544 pivots about the fulcrum 558 so that the coupling member 560 pulls the clamp arm 226 in the direction of arrow “K” moving the wire terminal 210 from the closed position, seen in FIG. 47, to the open position, seen in FIG. 48. The activating member 540 may also be referred to herein as a “push-lever” in the singular and “push-levers” in the plural.

Continuing to refer to FIGS. 47-49, an exemplary embodiment of a use scenario for the switch 10 of FIGS. 14, 15 and 46-49 described herein is shown. In this exemplary embodiment, a 30 amp, three-phase electrical motor 300 is controlled by a disconnect switch assembly 310. The disconnect switch assembly 310 includes an electrical enclosure or electrical box 312 having a main body 314 and a removable cover 316. For ease of description, the electrical enclosure or electrical box 312 may also be referred to herein as the “enclosure” in the singular and the “enclosures” in the plural. The enclosure 312 may be a weatherproof or watertight enclosure. A switch 10 is secured in the main body 314 of the enclosure 312. As described herein, the switch 10 includes wire termination assemblies 530 to terminate electrical conductors or wires within the enclosure 312. The switch 10 is shipped with the activating assembly 540 installed at least partially in the activating member openings 34 within the wire attachment portions 16 and 18. To connect wires 700 within the enclosure 312 to the switch 10, an installer, e.g., an electrician, first strips the insulation from the end of each wire. In the exemplary embodiment shown in FIGS. 14-15, the switch 10 is a three-pole switch that has six wire termination assemblies 530, such that six wires can be connected to the switch 10. The six wires include line side phase 1, phase 2 and phase 3 wires, and load side phase 1, phase 2 and phase 3 wires. However, it is also contemplated that each wire termination assemblies 530 could be configured to electrically connect more than one wire to the wire termination assemblies 530.

After the insulation is stripped from the end of each wire, the pushbuttons 542 of the push-levers 510 are pushed in the direction of arrow “J,” seen in FIG. 48. As the pushbutton 542 is pushed, the input arm portion 554 of the lever 544 pivots about the fulcrum 558 causing the coupling member 560 to pull the clamp arm 226 of the clamping member 214 in the direction of arrow “K,” as shown in FIG. 48. Moving the clamp arm 226 in the direction of arrow “K” causes the wire press member 230 and thus the wire terminal 210 to move from the closed position, seen in FIG. 47, to the open position, seen in FIG. 48. With the wire terminals 210 in the open position, the bare end of the electrical wires 700 are then inserted into the appropriate wire receiving openings 32 in the wire attachment portions 16 or 18 of the switch housing 12, seen in FIG. 46. The wire receiving openings 32 also guide the bare end of the wires 700 into the portion of the elongated opening 228 of the clamping member 214 between clamp brace 212 and wire press member 230, as shown in FIG. 48. When the bare end of each wire 700 is positioned between the clamp brace 212 and the wire press member 230, the respective pushbutton 542 is released by the installer. Releasing the pushbutton 542 removes the force applied to the biasing member 224 by the coupling member 560 pulling the clamp arm 226 in the direction of arrow “K.” Removing the pull force applied on the biasing member 224 causes the energy stored by the biasing member 224 to move the wire press member 230 in the direction of arrow “M,” seen in FIG. 49, to the closed position with sufficient force to secure or clamp the wire 700 between the clamp brace 212 and the wire press member 230 completing an electrically conductive path between the wire 700 and the wire termination assembly 200. In addition, the movement of the biasing member 224 in the direction of arrow “M” returns the pushbutton 542 toward its original position, seen in FIG. 47.

With the wires 700 connected to the switch 10 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 10 into engagement with the electrical contact pads 220 on the clamp brace 212 of the wire termination assemblies 200 completing an electrically conductive path from the wires 700 to the motor 300 turning the motor “on.”

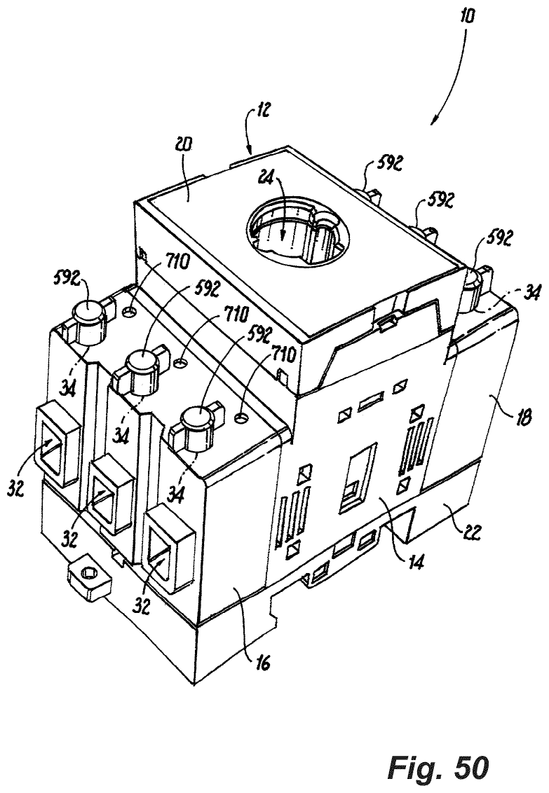

Referring now to FIGS. 50-53, another exemplary embodiment of a switch 10 according to the present disclosure is shown. The switch 10 includes similar features as described above for the embodiments of FIGS. 1-49 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. Within the main body portion 14 of the housing 12 are the components that perform the make and break functions of the switch 10. A non-limiting example of the components within the main body portion 14 that perform the make and break functions of the switch 10 are included in, for example, the HBLDS3RS Disconnect Switch sold by Hubbell Incorporated, which is incorporated herein in its entirety by reference. Generally, the main body portion 14 includes a plurality of spring loaded switch contacts 100, seen in FIGS. 3, 10, 51-53, that are accessible when the base 22 is removed from the housing 12. Each switch contact 100 acts as a jumper between corresponding pairs of wire termination assemblies 580 positioned at least partially within and accessible from the wire attachment portions 16 and 18. The top portion 20 of the housing 12 includes an on-off control assembly 24. The on-off control assembly 24 is operatively coupled to the switch contacts 100 such that the on-off control assembly 24 moves the switch contacts 100 between make and break positions. Each wire attachment portion 16 and 18 is secured to or integrally or monolithically formed into the main body portion 14. In the exemplary embodiment shown, each wire attachment portion 16 and 18 includes one or more wire termination chambers or cavities 30, similar to that seen in FIG. 33, one or more wire receiving openings 32 and one or more activating member openings 34, seen in FIG. 50. Each wire termination chamber or cavity 30 is configured to receive and position a wire termination assembly 580 within the wire attachment portion 16 or 18, similar to that shown in FIG. 33. In this configuration, one of the one or more wire receiving openings 32 and one of the one or more activating member openings 34 provide access from an exterior of the housing to one of the one or more wire termination chambers or cavities 30.

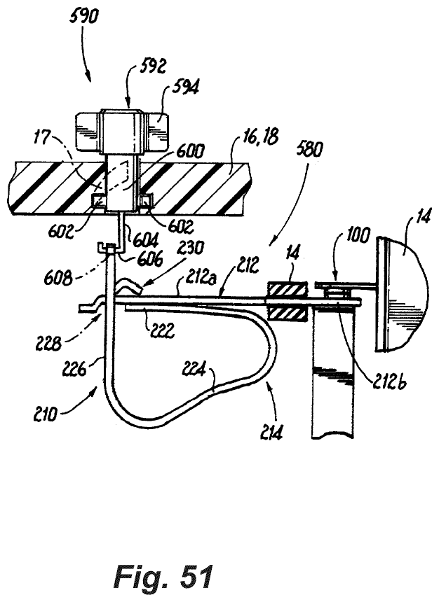

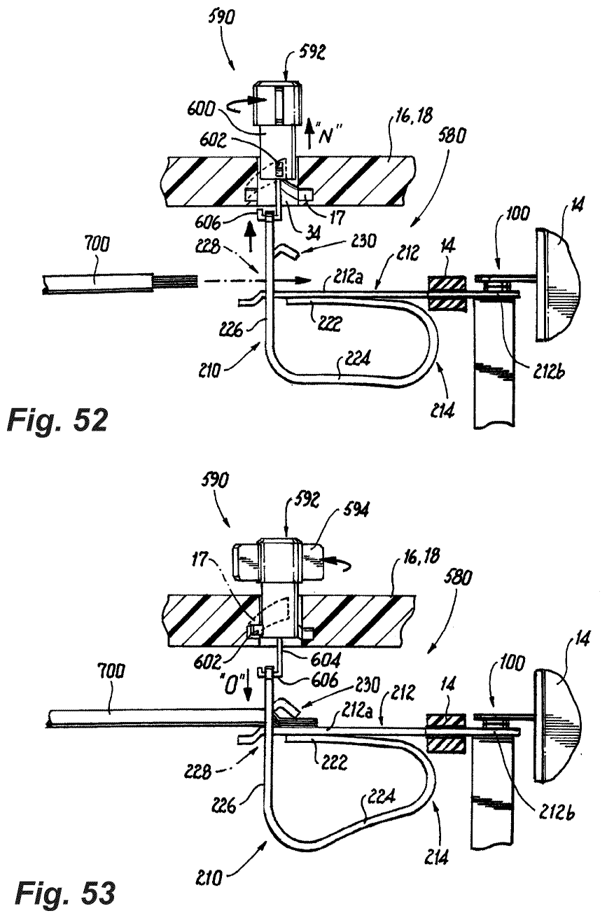

Continuing to refer to FIGS. 50-53, an exemplary embodiment of a wire termination assembly 580 according to the present disclosure is substantially similar to the wire termination assembly 200 described above, except that the one or more wire termination assemblies 580 are oriented within the wire attachment portions 16 and 18 such that the one or more activating member openings 34 extend through a top surface of the wire attachment portions 16 and 18, as shown in FIG. 50. Each wire termination assembly 580 is configured to receive and clamp a wire, such as wire 700 shown in FIG. 52, to the switch 10, and to mate with the switch contacts 100 of the switch 10, similar to that seen in FIG. 33. In the exemplary embodiment shown, the wire termination assembly 580 includes a wire terminal 210 and an activating member 590. The wire terminal 210 is at least partially made of an electrically conductive material, such as brass, copper or aluminum. In an exemplary embodiment, at least a portion of the wire terminal 210 is made of a resilient material with sufficient stiffness to flex when a mechanical load is applied and return to its normal position when the mechanical load is removed. An example of such a resilient material is spring steel. The wire terminal 210 is a mechanical clamping terminal that may use one or more clamping members 214 that can deflect under a mechanical load applied by the activating member 590 and recover to their initial shape when the mechanical load is removed. The energy stored by the one or more clamping members 214 should be sufficient to apply a constant and continuous force to mechanically secure one or more wires, e.g., wires 700 shown in FIG. 53, to the wire terminal 210. In the exemplary configuration shown in FIGS. 51-53, the wire terminal 210 includes a clamp brace 212 and a clamping member 214. The clamp brace 212 is an electrically conductive fixed terminal body that may be a substantially planar shaped member or an arcuate shaped member having a first end 212a secured to the clamping member 214. The clamp brace 212 may be secured to the clamping member 214 by, for example, mechanically fitting, e.g., clipping, the clamp brace 212 to the clamping member 214 or a solder joint, a brazed joint, or a welded joint. The clamping member 214 includes a brace contact member 222, a biasing member 224 and a clamp arm 226 as described above. The wire terminal 210 is the same as the wire terminal 210 described above and shown in FIGS. 8-13, such that a more detailed description thereof is not repeated.

As noted, the wire terminal 210 can connect to electrical conductors of different sizes. For example, if the electrical wiring device, e.g., switch 10, is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring device is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring device is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit. As another example, if the blade-type electrical receptacle is rated for 50 amps, then the wire terminal 210 should also be rated for at least 50 amps. The wire size, i.e., the bare conductor size, for 50 amps is 6 AWG wire such that the clamp arm 226 should be able to move to an open position where the outer diameter of 6 AWG wire can fit.

Referring to FIGS. 51-53, an exemplary embodiment of the activating member 590 is shown. In this exemplary embodiment, the activating member 590 is a rod or pin having a head 592 and a stem 600. The activating member 590 is preferably made of suitably rigid electrical insulating materials, such as plastic materials. Non-limiting examples of plastic materials include injection molded thermoplastic materials, such as Nylon. The activating member 590 may be an integrally or monolithically formed member or the activating member 590 may be separate components joined together by adhesives, welds or mechanical fasteners. In the exemplary embodiments shown, the activating member 490 is an integrally or monolithically formed member.

The head 592 of the activating member 590 is preferably dimensioned to be larger than the stem 600 so that the head 592 does not enter the activating member openings 34 in the wire attachment portions 16 and 18. The head 592 may be configured to provide grip enhancing features to help facilitate rotation of the activating member 590 when activating, e.g., moving, the clamping member 214 of the wire terminal 210 between closed and open positions, as described below. As an example, a grip enhancing feature may be fins, pads or other structures 594 in, on or extending from the head 592. Another example of a grip enhancing feature may be a textured surface on the fins, pads or other structures 594. Non-limiting examples of textured surfaces include coatings, striations, knurling and/or small narrow grooves. The stem 600 of the activating member 590 is configured to extend into one of the one or more activating member openings 34, as shown in FIG. 51. The stem 600 may be cylindrical structure with a circular cross-section, as shown in FIGS. 51-53. The stem 600 includes one or more pins 602 that ride within the track 17 in the wire attachment portions 16 and 18. In this exemplary embodiment, the track 17 is partial helical track configured and dimensioned to receive the one or more pins 602 so that the one or more pins can ride along the track 17 as the head 592 is rotated. In another exemplary embodiment, the track 17 could be a continuous helical track configured and dimensioned to receive the one or more pins 602 so that the pins can ride along the track 17 as the head 592 is rotated. The stem 600 has a connecting pin 604 that extends into the wire termination cavity 30 and couples the stem 600 to a coupling member 606 used to couple the stem 600 to the clamp arm 226 of the clamping member 214. For example, the coupling member 606 may be a hook like structure that fits within an aperture 608 in the clamp arm 226 of the clamping member 214. In this configuration, having the pins 602 ride within the track 17 causes the coupling member 606 to pull on the clamp arm 226 of the clamping member 214.

Continuing to refer to FIGS. 51-53, an exemplary embodiment of a use scenario for the switch 10 of FIGS. 14, 15 and 50-53 described herein is shown. In this exemplary embodiment, a 30 amp, three-phase electrical motor 300 is controlled by a disconnect switch assembly 310. The disconnect switch assembly 310 includes an electrical enclosure or electrical box 312 having a main body 314 and a removable cover 316. For ease of description, the electrical enclosure or electrical box 312 may also be referred to herein as the “enclosure” in the singular and the “enclosures” in the plural. The enclosure 312 may be a weatherproof or watertight enclosure. A switch 10 is secured in the main body 314 of the enclosure 312. As described herein, the switch 10 includes wire termination assemblies 580 to terminate electrical conductors or wires within the enclosure 312. The switch 10 is shipped with the activating member 580 at least partially installed in the activating member openings 34 within the wire attachment portions 16 and 18. To connect wires 700 within the enclosure 312 to the switch 10, an installer, e.g., an electrician, first strips the insulation from the end of each wire. In the exemplary embodiment shown in FIGS. 14-15, the switch 10 is a three-pole switch that has six wire termination assemblies 580, such that six wires can be connected to the switch 10. The six wires include line side phase 1, phase 2 and phase 3 wires, and load side phase 1, phase 2 and phase 3 wires. However, it is also contemplated that each wire termination assemblies 580 could be configured to electrically connect more than one wire to the wire termination assemblies 580.

After the insulation is stripped from the end of each wire, the heads 592 of the activating members 590 are rotated counterclockwise so that the one or more pins 602 ride within the tracks 17 in the wire attachment portions 16 and 18. Since the tracks 17 are partial helical tracks configured and dimensioned to receive the one or more pins 602, the one or more pins 602 ride along the track 17 in the direction of arrow “N” as shown in FIG. 52. Movement of the activating members 590 in the direction of arrow “N” causes the coupling member 606 to pull the clamp arm 226 of the clamping member 214 in the direction of arrow “N.” Moving the clamp arm 226 in the direction of arrow “N” causes the wire press member 230 and thus the wire terminal 210 to move from the closed position, seen in FIG. 51, to the open position, seen in FIG. 52. With the wire terminals 210 in the open position, the bare end of the electrical wires 700 are then inserted into the appropriate wire receiving openings 32 in the wire attachment portions 16 or 18 of the switch housing 12, seen in FIG. 50. The wire receiving openings 32 also guide the bare end of the wires 700 into the portion of the elongated opening 228 of the clamping member 214 between clamp brace 212 and wire press member 230, as shown in FIG. 52. When the bare end of each wire 700 is positioned between the clamp brace 212 and the wire press member 230, the respective head 592 of the activating members 590 is rotated clockwise causing the pins 602 to move along the track 17 so that the stem 600 moves in the direction of arrow “0” shown in FIG. 53. Clockwise rotation of the activating members 590 removes the force applied to the biasing member 224 by the clamp arm 226 as described above. Removing the pull force applied on the biasing member 224 by the clamp arm 226 causes the energy stored by the biasing member 224 to move the wire press member 230 in the direction of arrow “O” to the closed position with sufficient force to secure or clamp the wire 700 between the clamp brace 212 and the wire press member 230 completing an electrically conductive path between the wire 700 and the wire termination assembly 200.

With the wires 700 connected to the switch 10 and the motor 300, when the control knob 318 rotatably attached to the switch cover 316 is rotated from an “off” position to an “on” position, the drive rod 320 attached to the control knob 318 rotates the on-off control assembly 24 causing contact pads 102 the switch contact 100 of the switch 10 into engagement with the electrical contact pads 220 on the clamp brace 212 of the wire termination assemblies 200 completing an electrically conductive path from the wires 700 to the motor 300 turning the motor on.

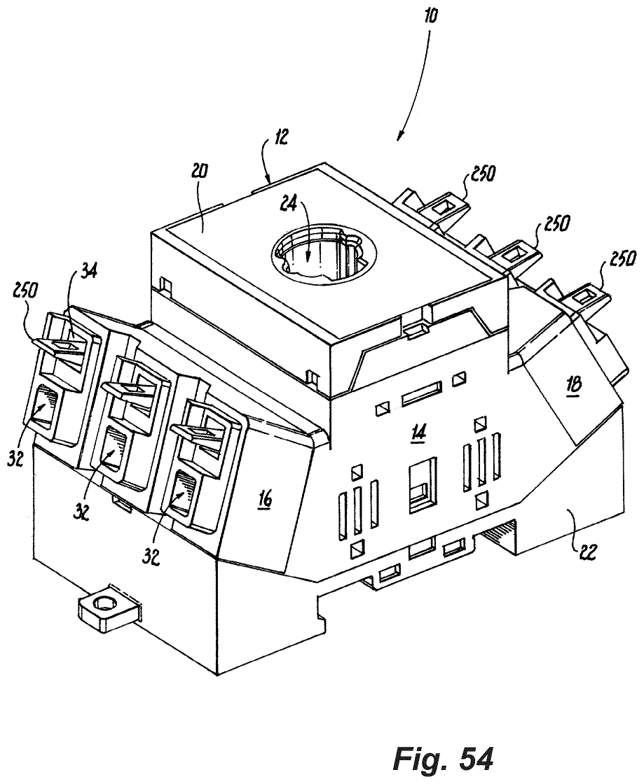

Referring now to FIGS. 54-57, another exemplary embodiment of a switch 10 according to the present disclosure is shown. The switch 10 includes similar features as described above for the embodiments of FIGS. 1-53 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. However, in this exemplary embodiment, the main body portion 14 and the base 22 are configured to angle the wire attachment portions 16 and 18 to make it easier to install wires into the wire attachment portions 16 and 18 with the switch 10 installed in an enclosure, such as the electrical enclosure 312 shown in FIGS. 14-17. The angle orients the wire attachment portions 16 and 18 to face toward a cover 316 of the enclosure.

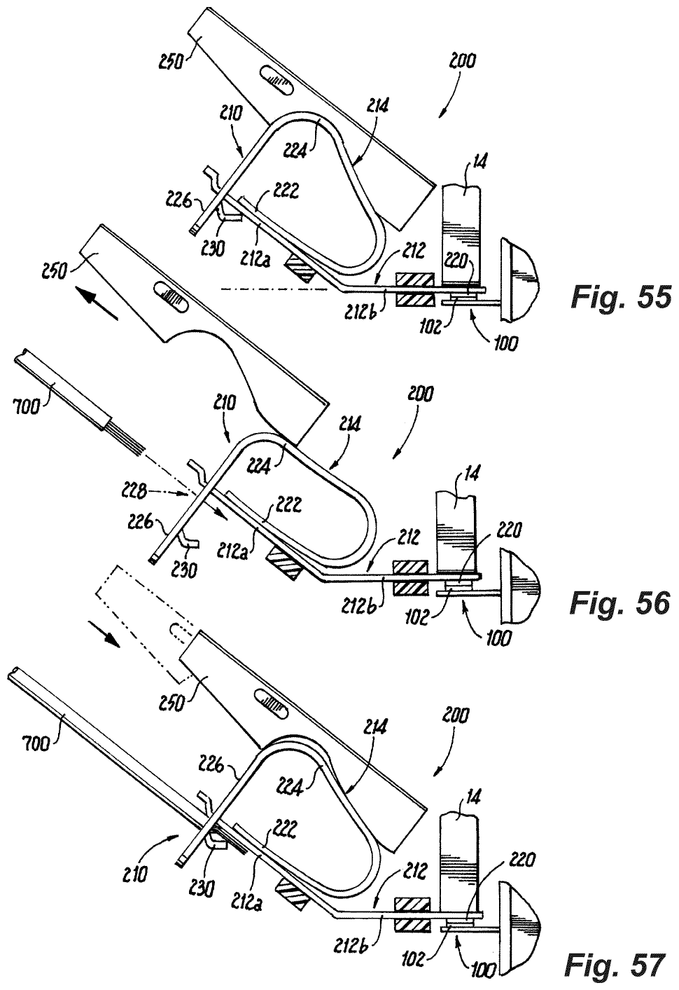

Turning to FIGS. 55-57, the wire termination assembly 200 includes a wire terminal 210 and an activating member 250. The wire termination assembly 200 is substantially the same as the wire termination assembly 200 described above, such that a detailed description of the wire terminal 210 and the activating member 250 is not repeated. However, in this exemplary embodiment, the second end 212b of the clamp brace 212 of the wire terminal 210 is angled so that the electrical contact pad 220 is aligned with the electrical contact pad 102 on the switch contact 100, as shown in FIGS. 55-57.

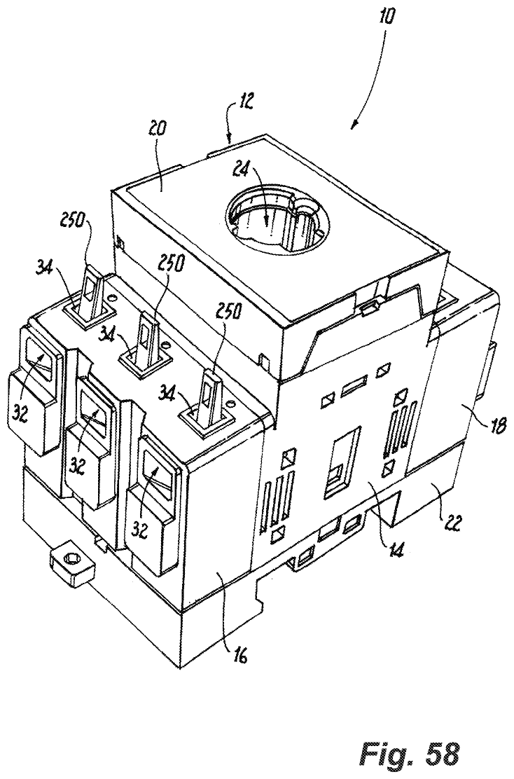

Referring now to FIGS. 58-61, another exemplary embodiment of a switch 10 according to the present disclosure is shown. The switch 10 includes similar features as described above for the embodiments of FIGS. 1-57 such that like elements use the same reference numerals. In this exemplary embodiment, the switch 10 has a housing 12 that includes a main body portion 14, a pair of wire attachment portions 16 and 18, a top portion 20 and a base 22. The housing 12 is preferably made of suitably rigid electrical insulating materials, such as plastic materials, including injection molded thermoplastic materials, such as Nylon, and can be a standalone unit or configured to fit within an electrical enclosure. However, in this exemplary embodiment, the one or more activating member openings 34 extend through a top surface of the wire attachment portions 16 and 18, as shown in FIG. 58.

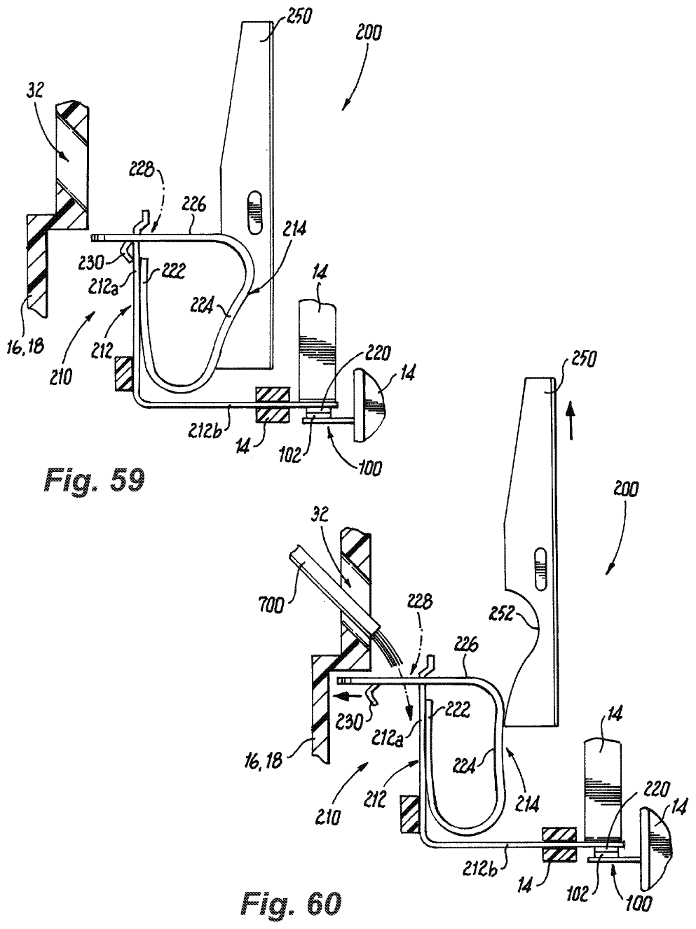

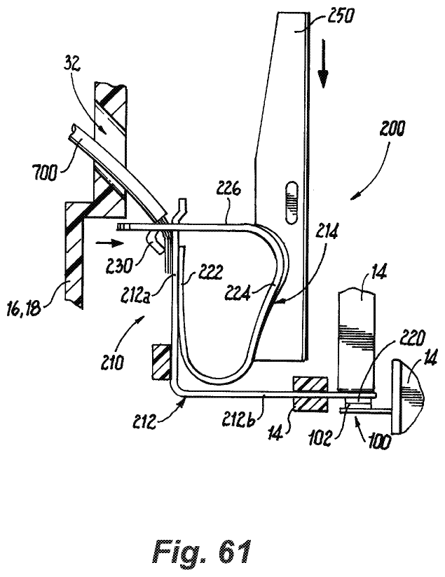

The wire termination assembly 200 in this exemplary embodiment includes the wire terminal 210 and the activating member 250 described above, so that a detailed description of the wire terminal 210 and the activating member 250 is not repeated. However, in this exemplary embodiment, with the one or more activating member openings 34 extending through a top surface of the wire attachment portions 16 and 18, the one of the one or more wire termination assemblies 200 are oriented within the wire attachment portions 16 and 18 to be aligned with the one or more activating member openings 34. In the orientation of FIG. 58, the activating members 250 extend at least partially from the top surface of the wire attachment portions 16 and 18, as shown in FIG. 58. In this orientation, the clamping member 214 is oriented within the wire termination cavity 30 so that the opening 228 in the clamp arm 226 is aligned with one of the one or more activating member openings 34, as shown in FIGS. 59-61. In addition, the second end 212b of the clamp brace 212 of the wire terminal 210 is angled so that the electrical contact pad 220 is aligned with the electrical contact pad 102 on the switch contact 100, as shown in FIGS. 59-60. In addition, in this configuration the one or more wire receiving openings 32 are angled to make it easier to install wires into the wire attachment portions 16 and 18 when the switch 10 is installed in an enclosure, such as the electrical enclosure 312 shown in FIGS. 14-17.

In each embodiment described herein and/or contemplated by the present disclosure, an upper exterior surface of the wire attachment portions 16 and 18 may include one or more contact apertures or openings 710. Each of the one or more contact apertures or openings 710 extend from the upper exterior surface of the wire attachment portions 16 and 18 into one of the one or more wire termination cavities 30. The one or more contact apertures or openings 710 permit one or more contact pins or connectors (not shown) to be inserted into and through the one or more contact apertures 710 into the one of the one or more wire termination cavities 30 such that the one or more contact pins or connectors (not shown) can engage or contact the one of the one or more wire termination assemblies 200, 400, 440, 500, 530 and 580 positioned in the one of the one or more wire termination cavities 30. For example, one or more contact pins or connectors (not shown) may be electrically connected to a circuit board (not shown) positioned within an electrical enclosure or electrical box, such as the electrical enclosure 312 seen in FIGS. 14-17. The circuit board may include one or more indicators that provide status information about the operation of the switch 10. A more detailed description of the one or more contact pins or connectors and the circuit board is included in commonly owned U.S. Application No. 63/416,625 filed on Oct. 17, 2022 and U.S. application Ser. No. 18/484,487 filed Oct. 11, 2023, both of which are incorporated herein in their entirety by reference.

While exemplary embodiments have been chosen to illustrate the invention, it will be understood by those skilled in the art that various changes, modifications, additions, and substitutions are possible, without departing from the scope and spirit of the invention.

What is claimed is:

1. A multi-pole electrical wiring device comprising:
a housing having an interior, at least one wire receiving opening in a side wall of the housing and at least one activating member opening in a top wall of the housing, wherein at least a portion of the interior is hollow;
at least one wire termination assembly positioned in the hollow portion of the interior of the housing such that the at least one wire termination assembly is accessible from the at least one wire receiving opening;
at least one activating member extending at least partially through the at least one activating member opening, the activating member being interactive with the at least one wire termination assembly such that movement of the activating member in a first direction to a first position causes the at least one wire termination assembly to automatically move to a closed position clamping a wire inserted into the wire receiving opening and positioned in the at least one wire termination assembly, and such that movement of the activating member in a second direction to a second position causes the at least one wire termination assembly to move to an open position releasing the wire within the at least one wire termination assembly.

2. The electrical wiring device according to claim 1, wherein the at least one wire termination assembly includes a wire press member used when clamping the wire positioned in the at least one wire termination assembly.

3. The electrical wiring device according to claim 1, wherein the at least one wire termination assembly includes a biasing member.

4. The electrical wiring device according to claim 3, wherein the biasing member comprises a spring.

5. The electrical wiring device according to claim 1, wherein the at least one activating member remains in the first position or the second position until manually moved.

6. The electrical wiring device according to claim 1, wherein the movement of the activating member in the second direction is opposite the movement of the activating member in the first direction.

7. The electrical wiring device according to claim 1, wherein the movement of the activating member in the first direction and the second direction is linear motion.

8. The electrical wiring device according to claim 1, wherein the movement of the activating member in the first direction and the second direction is one of linear motion, rotational motion, torque motion, pivotable motion and twist motion.

9. The electrical wiring device according to claim 1, wherein movement of the activating member in the first direction is outward relative to the housing, and wherein movement of the activating member in the second direction is inward relative to the housing.

10. The electrical wiring device according to claim 1, wherein when in the closed position the at least one wire termination assembly can clamp the wire with a force that is substantially perpendicular to a longitudinal axis of the wire.

11. A multi-pole electrical wiring device comprising:
a housing having an interior, a plurality of wire receiving openings in a side wall of the housing and a plurality of activating member openings in a top wall of the housing, wherein at least a portion of the interior is hollow, wherein each of the plurality of wire receiving openings provides access from an exterior of the housing to the hollow portion of the interior of the housing, and wherein each of the plurality of activating member openings provides access from the exterior of the housing to the hollow portion of the interior of the housing; and
a plurality of line side wire termination assemblies positioned in the hollow portion of the interior of the housing such that one of the plurality of line side wire termination assemblies is accessible from one of the plurality of wire receiving openings and one of the plurality of activating member openings;
wherein each of the plurality of line side wire termination assemblies includes:
a wire terminal including a clamp brace and a clamping member, the clamping member being movable between a closed position where a wire can be clamped between the clamping member and the clamp brace, and an open position where the wire can be inserted through the one of the plurality of wire receiving openings in the housing and between the clamping member and the clamp brace; and
an activating member extending at least partially through the one of the plurality of activating member openings in the housing, the activating member being interactive with the clamping member such that movement of the activating member in a first direction causes the activating member to apply a mechanical load to the clamping member causing the clamping member to move from the closed position to the open position, and movement of the activating member in a second direction removes the mechanical load from the clamping member so that the clamping member moves from the open position to the closed position; and
a plurality of load side wire termination assemblies positioned in the hollow portion of the interior of the housing such that one of the plurality of load side wire termination assemblies is accessible from one of the plurality of wire receiving openings and one of the plurality of activating member openings;
wherein each of the plurality of load side wire termination assemblies includes:
a wire terminal including a clamp brace and a clamping member, the clamping member being movable between a closed position where a wire can be clamped between the clamping member and the clamp brace, and an open position where the wire can be inserted through the one of the plurality of wire receiving openings in the housing and between the clamping member and the clamp brace; and
an activating member extending at least partially through the one of the plurality of activating member openings in the housing, the activating member being interactive with the clamping member such that movement of the activating member in a first direction causes the activating member to apply a mechanical load to the clamping member causing the clamping member to move from the closed position to the open position, and movement of the activating member in a second direction removes the mechanical load from the clamping member so that the clamping member moves from the open position to the closed position.

12. The electrical wiring device according to claim 11, wherein the clamping member for the line side wire termination assemblies and the load side wire termination assemblies includes a wire press member such that the wire can be clamped between the wire press member and the clamp brace.

13. The electrical wiring device according to claim 11, wherein the clamping member for the line side wire termination assemblies and the load side wire termination assemblies includes a biasing member.

14. The electrical wiring device according to claim 11, wherein the activating member for the line side wire termination assemblies and the load side wire termination assemblies remains in the first position or the second position until manually moved.

15. The electrical wiring device according to claim 11, wherein the movement of the activating member for the line side wire termination assemblies and the load side wire termination assemblies in the second direction is opposite the movement of the activating member in the first direction.

16. The electrical wiring device according to claim 11, wherein the movement of the activating member for the line side wire termination assemblies and the load side wire termination assemblies in the first direction and the second direction is substantially perpendicular to the clamp brace.

17. The electrical wiring device according to claim 11, wherein the movement of the activating member for the line side wire termination assemblies and the load side wire termination assemblies in the first direction and the second direction is linear motion.

18. The electrical wiring device according to claim 11, wherein the movement of the activating member for the line side wire termination assemblies and the load side wire termination assemblies in the first direction and the second direction is one of linear motion, rotational motion, torque motion, pivotable motion and twist motion.

19. The electrical wiring device according to claim 11, wherein movement of the activating member for the line side wire termination assemblies and the load side wire termination assemblies in the first and second directions is relative to the clamping member.

20. The electrical wiring device according to claim 11, wherein movement of the activating member for the line side wire termination assemblies and the load side wire termination assemblies in the first direction is inward relative to the housing and wherein movement of the activating member for the line side wire termination assemblies and the load side wire termination assemblies in the second direction is outward relative to the housing.

21. The electrical wiring device according to claim 11, wherein when in the closed position the clamping member for the line side wire termination assemblies and the load side wire termination assemblies can clamp the wire with a force that is substantially perpendicular to a longitudinal axis of the wire.

22. A multi-pole electrical wiring device comprising:
a housing having an interior, a plurality of wire receiving openings in a side wall of the housing and a plurality of activating member openings in a top wall of the housing, wherein at least a portion of the interior is hollow, wherein each of the plurality of wire receiving openings provides access from an exterior of the housing to the hollow portion of the interior of the housing, and wherein each of the plurality of activating member openings provides access from the exterior of the housing to the hollow portion of the interior of the housing; and
a plurality of line side wire termination assemblies positioned in the hollow portion of the interior of the housing such that one of the plurality of line side wire termination assemblies is accessible from one of the plurality of wire receiving openings and one of the plurality of activating member openings;
wherein each of the plurality of line side wire termination assemblies includes:
a wire terminal including a clamp brace and a clamping member, the clamping member being movable between a closed position where a wire can be clamped between the clamping member and the clamp brace, and an open position where the wire can be inserted through the one of the plurality of wire receiving openings in the housing and between the clamping member and the clamp brace; and
an activating member extending at least partially through the one of the plurality of activating member openings in the housing, the activating member being interactive with the clamping member such that movement of the activating member in a first direction causes the activating member to move the clamping member from the closed position to the open position, and movement of the activating member in a second direction permits the clamping member to automatically move from the open position to the closed position; and
a plurality of load side wire termination assemblies positioned in the hollow portion of the interior of the housing such that one of the plurality of load side wire termination assemblies is accessible from one of the plurality of wire receiving openings and one of the plurality of activating member openings;
wherein each of the plurality of load side wire termination assemblies includes:
a wire terminal including a clamp brace and a clamping member, the clamping member being movable between a closed position where a wire can be clamped between the clamping member and the clamp brace, and an open position where the wire can be inserted through the one of the plurality of wire receiving openings in the housing and between the clamping member and the clamp brace; and
an activating member extending at least partially through the one of the plurality of activating member openings in the housing, the activating member being interactive with the clamping member such that movement of the activating member in a first direction causes the activating member to move the clamping member from the closed position to the open position, and movement of the activating member in a second direction permits the clamping member to automatically move from the open position to the closed position.

23. The electrical wiring device according to claim 22, wherein the clamping member for the line side wire termination assemblies and the load side wire termination assemblies includes a wire press member such that the wire can be clamped between the wire press member and the clamp brace.

24. The electrical wiring device according to claim 22, wherein the clamping member for the line side wire termination assemblies and the load side wire termination assemblies is a biasing member.

25. The electrical wiring device according to claim 22, wherein the activating member for the line side wire termination assemblies and the load side wire termination assemblies remains in the first position or the second position until manually moved.

26. The electrical wiring device according to claim 22, wherein the movement of the activating member for the line side wire termination assemblies and the load side wire termination assemblies in the second direction is opposite the movement of the activating member in the first direction.

27. The electrical wiring device according to claim 22, wherein the movement of the activating member for the line side wire termination assemblies and the load side wire termination assemblies in the first direction and the second direction is substantially perpendicular to the clamp brace.

28. The electrical wiring device according to claim 22, wherein the movement of the activating member for the line side wire termination assemblies and the load side wire termination assemblies in the first direction and the second direction is linear motion.

29. The electrical wiring device according to claim 22, wherein the movement of the activating member for the line side wire termination assemblies and the load side wire termination assemblies in the first direction and the second direction is one of linear motion, rotational motion, torque motion, pivotable motion and twist motion.

30. The electrical wiring device according to claim 22, wherein movement of the activating member for the line side wire termination assemblies and the load side wire termination assemblies in the first and second directions is relative to the clamping member.

31. The electrical wiring device according to claim 22, wherein movement of the activating member for the line side wire termination assemblies and the load side wire termination assemblies in the first direction is inward relative to the housing and wherein movement of the activating member in the second direction is outward relative to the housing.

32. The electrical wiring device according to claim 22, wherein when in the closed position the clamping member for the line side wire termination assemblies and the load side wire termination assemblies can clamp the wire with a force that is substantially perpendicular to a longitudinal axis of the wire.

33. A multi-pole electrical wiring device comprising:
a housing having a plurality of wire receiving openings in a side wall of the housing and a plurality of activating member openings in a top wall of the housing, wherein each of the plurality of wire receiving openings provides access from an exterior of the housing to an interior of the housing, and wherein each of the plurality of activating member openings provides access from the exterior of the housing to the interior of the housing;
a plurality of line side wire termination assemblies positioned in the interior of the housing such that one of the plurality of line side wire termination assemblies is accessible from one of the plurality of wire receiving openings and one of the plurality of activating member openings;
wherein each of the plurality of the line side wire termination assemblies includes:
a wire terminal including a clamp brace and a clamping member, the clamping member being movable between a closed position where a wire can be clamped between the clamping member and the clamp brace, and an open position where the wire can be inserted between the clamping member and the clamp brace; and
an activating member extending at least partially through the one of the plurality of activating member openings in the housing, the activating member being interactive with the clamping member such that movement of the activating member in a first direction from a first position to a second position causes the activating member to move the clamping member from the closed position to the open position, and movement of the activating member in a second direction permits the clamping member to automatically move from the open position to the closed position, wherein the activating member remains in the first position or the second position until manually moved; and
a plurality of load side wire termination assemblies positioned in the interior of the housing such that one of the plurality of load side wire termination assemblies is accessible from one of the plurality of wire receiving openings and one of the plurality of activating member openings;
wherein each of the plurality of the load side wire termination assemblies includes:
a wire terminal including a clamp brace and a clamping member, the clamping member being movable between a closed position where a wire can be clamped between the clamping member and the clamp brace, and an open position where the wire can be inserted between the clamping member and the clamp brace; and
an activating member extending at least partially through the one of the plurality of activating member openings in the housing, the activating member being interactive with the clamping member such that movement of the activating member in a first direction from a first position to a second position causes the activating member to move the clamping member from the closed position to the open position, and movement of the activating member in a second direction permits the clamping member to automatically move from the open position to the closed position, wherein the activating member remains in the first position or the second position until manually moved.

34. The electrical wiring device according to claim 33, wherein the clamping member for the line side wire termination assemblies and the load side wire termination assemblies includes a wire press member such that the wire can be clamped between the wire press member and the clamp brace.

35. The electrical wiring device according to claim 33, wherein the clamping member for the line side wire termination assemblies and the load side wire termination assemblies includes a biasing member.

36. The electrical wiring device according to claim 33, wherein the movement of the activating member for the line side wire termination assemblies and the load side wire termination assemblies in the second direction is opposite the movement of the activating member in the first direction.

37. The electrical wiring device according to claim 33, wherein the movement of the activating member for the line side wire termination assemblies and the load side wire termination assemblies in the first direction and the second direction is substantially perpendicular to the clamp brace.

39. The electrical wiring device according to claim 33, wherein the movement of the activating member for the line side wire termination assemblies and the load side wire termination assemblies in the first direction and the second direction is linear motion.

40. The electrical wiring device according to claim 33, wherein the movement of the activating member for the line side wire termination assemblies and the load side wire termination assemblies in the first direction and the second direction is one of linear motion, rotational motion, torque motion, pivotable motion and twist motion.

41. The electrical wiring device according to claim 33, wherein when in the closed position the clamping member for the line side wire termination assemblies and the load side wire termination assemblies can clamp the wire with a force that is substantially perpendicular to a longitudinal axis of the wire.

42. The electrical wiring device according to claim 33, wherein movement of the activating member for the line side wire termination assemblies and the load side wire termination assemblies in the first and second directions is relative to the clamping member.

43. The electrical wiring device according to claim 33, wherein movement of the activating member for the line side wire termination assemblies and the load side wire termination assemblies in the first direction is inward relative to the housing and wherein movement of the activating member in the second direction is outward relative to the housing.
